(19) United States
(12) Patent Application Publication
(10) Pub. No.: US 2007/0008277 A1
(43) Pub. Date: Jan. 11, 2007

(54) Image data processing apparatus and image data processing method

(75) Inventors: Haruhiko Okumura, Fujisawa-shi (JP); Goh Itoh, Tokyo (JP); Masahiro Baba, Yokohama-shi (JP); Masaki Miyatake, Konosu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignees: KABUSHIKI KAISHA TOSHIBA; TOSHIBA MATSUSHITA DISPLAY TECHNOLOGY CO., LTD.

(21) Appl. No.: 11/403,983

(22) Filed: Apr. 14, 2006

(30) Foreign Application Priority Data
Jul. 8, 2005 (JP) P2005-200781

(51) Int. Cl. G09G 3/36

(52) U.S. Cl. 345/104

(57) ABSTRACT

An image data processing apparatus divides image data into a plurality of pixel data including a set of pixel data corresponding to a set of signal lines of a display device selectively controlled by an element, and stores the divided image data. Corresponding to one of the divided plurality of image data, one of the stored plurality of pixel data is selected to generate differential data.

### CROSS-REFERENCE TO THE INVENTION

This application is based upon and claims the benefit of priority from the prior Japanese Patent Application No. 2005-200781, filed on Jul. 8, 2005; the entire contents of which are incorporated herein by reference.

### BACKGROUND OF THE INVENTION

1. Field of the Invention

The present invention relates to an image data processing apparatus and an image data processing method.

2. Description of the Related Art

Due to the progress in enlargement of the screen of a display device and increase of definition thereof, an amount of information required for driving a display device has been increased, and moreover the frequency of a signal transmitted for driving the display device has been increased. Such increase of a data amount in a transmitted signal (increase in frequency) causes electro-magnetic interference (EMI) to the vicinity thereof. Accordingly, there is an increasing need to reduce the electro-magnetic interference (EMI) caused by an electronic apparatus having the display device.

As a method of reducing the EMI emitted by an electronic apparatus having the display device, “LVDS,” “PanelLink,” “SSCG,” and other systems are proposed (refer to Nikkei Electronics, pp. 123-148, Nov. 3, 1997 (No. 702), and Japanese Patent Laid-open Application No. 2000-20031).

Now, display devices which switch and drive a plurality of signal lines have been used increasingly. An image signal on one scan line is divided into a plurality of signals, and a divided image signal is outputted by a signal line being switched according to its division to thereby drive the display device. By dividing the image signal on one scan line into a plurality of blocks and selecting a signal line to display, the number of elements for controlling signal lines can be reduced.

### SUMMARY OF THE INVENTION

An object of the present invention is to provide an image data processing apparatus and an image data processing method which are capable of effectively reducing occurrence of an electromagnetic wave when switching and driving a plurality of signal lines.

An image data processing apparatus according to an aspect of the present invention includes a dividing unit configured to divide image data including a plurality of pixel data into the plurality of pixel data including a set of pixel data corresponding to a set of signal lines of a display device selectively controlled by an element; a storing unit configured to store the plurality of pixel data divided by the dividing unit; a selecting unit configured to select a first pixel data from the plurality of pixel data stored by the storing unit corresponding to a second pixel data included in the plurality of pixel data divided by the dividing unit; and a differentiating unit configured to generate differential data from the first pixel data selected by the selecting unit and the second pixel data included in the plurality of pixel data divided by the dividing unit.

An image data processing method according to an aspect of the present invention includes dividing image data including a plurality of pixel data into the plurality of pixel data including a set of pixel data corresponding to a set of signal lines of a display device selectively controlled by an element; storing the divided plurality of pixel data; selecting a first pixel data from the stored plurality of pixel data corresponding to a second pixel data included in the divided plurality of pixel data; and generating differential data from the first pixel data and the second pixel data.

### BRIEF DESCRIPTION OF THE DRAWINGS

FIG. 1 is a block diagram representing a display system according to a first embodiment of the present invention.

FIG. 2 is a flowchart representing an example of an operation procedure of an image data transmitting device.

FIG. 3 is a flowchart representing an example of an operation procedure of an image data receiving device.

FIG. 4A is a schematic diagram showing an example of a selection order of pixels for the case where the number of divisions is 2.

FIG. 4B is a schematic diagram showing an example of divided and sampled image data for the case where the number of divisions is 2.

FIG. 4C is a schematic diagram showing an example of time-compressed image data for the case where the number of divisions is 2.

FIG. 4D is a schematic diagram showing an example of selection rules for the case where the number of divisions is 2.

FIG. 5A is a schematic diagram showing another example of a selection order of pixels for the case where the number of divisions is 2.

FIG. 5B is a schematic diagram showing another example of divided and sampled image data for the case where the number of divisions is 2.

FIG. 5C is a schematic diagram showing another example of time-compressed image data for the case where the number of divisions is 2.

FIG. 5D is a schematic diagram showing another example of selection rules for the case where the number of divisions is 2.

FIG. 6A is a schematic diagram showing another example of a selection order of pixels for the case where the number of divisions is 3.

FIG. 6B is a schematic diagram showing another example of divided and sampled image data for the case where the number of divisions is 3.

FIG. 6C is a schematic diagram showing another example of time-compressed image data for the case where the number of divisions is 3.

FIG. 7A is a schematic diagram showing an example of a selection order of pixels for the case where the number of divisions is 4.

FIG. 7B is a schematic diagram showing an example of divided and sampled image data for the case where the number of divisions is 4.

FIG. 7C is a schematic diagram showing an example of time-compressed image data for the case where the number of divisions is 4.

FIG. 8A is a schematic diagram showing another example of a selection order of pixels for the case where the number of divisions is 4.

FIG. 8B is a schematic diagram showing another example of divided and sampled image data for the case where the number of divisions is 4.

FIG. 8C is a schematic diagram showing another example of time-compressed image data for the case where the number of divisions is 4.

FIG. 9A is a schematic diagram showing an example of a selection order of pixels for the case where the number of divisions is 5.

FIG. 9B is a schematic diagram showing an example of divided and sampled image data for the case where the number of divisions is 5.

FIG. 9C is a schematic diagram showing an example of time-compressed image data for the case where the number of divisions is 5.

FIG. 10A is a schematic diagram showing an example of a selection order of pixels for the case where the number of divisions is 2.

FIG. 10B is a schematic diagram showing an example of divided and sampled image data for the case where the number of divisions is 2.

FIG. 10C is a schematic diagram showing an example of time-compressed image data for the case where the number of divisions is 2.

FIG. 10D is a schematic diagram showing an example of selection rules for the case where the number of divisions is 2.

FIG. 11 is a view showing a timing chart for 2 number of divisions.

FIG. 12 is a view showing a timing chart for 2 number of divisions.

FIG. 13 is a view showing a timing chart for 2 number of divisions.

FIG. 14 is a view showing a timing chart for 3 number of divisions.

FIG. 15 is a view showing a timing chart for 3 number of divisions.

FIG. 16 is a view showing a timing chart for 3 number of divisions.

FIG. 17 is a view showing a timing chart for 3 number of divisions.

FIG. 18 is a view showing a timing chart for 4 number of divisions.

FIG. 19 is a view showing a timing chart for 4 number of divisions.

FIG. 20 is a view showing a timing chart for 4 number of divisions.

FIG. 21 is a view showing a timing chart for 4 number of divisions.

FIG. 22 is a view showing a timing chart for 5 number of division.

FIG. 23 is a view showing a timing chart for 5 number of divisions.

FIG. 24 is a view showing a timing chart for 5 number of divisions.

FIG. 25 is a view showing a timing chart for 5 number of divisions.

FIG. 26 is a block diagram representing a display system according to a modification example of the first embodiment of the present invention.

FIG. 27 is a block diagram representing a display system according to a second embodiment of the present invention.

FIG. 28 is a flowchart representing an example of an operation procedure of an image data transmitting device according to the second embodiment of the present invention.

FIG. 29 is a flowchart representing an example of an operation procedure of an image data receiving device according to the second embodiment of the present invention.

FIG. 30 is a view showing an example of a timing chart for the display system according to the second embodiment of the present invention.

FIG. 31 is a view showing an example of a timing chart for the display system according to the second embodiment of the present invention.

FIG. 32 is a view showing an example of a timing chart for the display system according to the second embodiment of the present invention.

### DESCRIPTION OF THE EMBODIMENTS

Hereinafter, embodiments of the present invention will be described in detail with reference to the drawings.

### First Embodiment

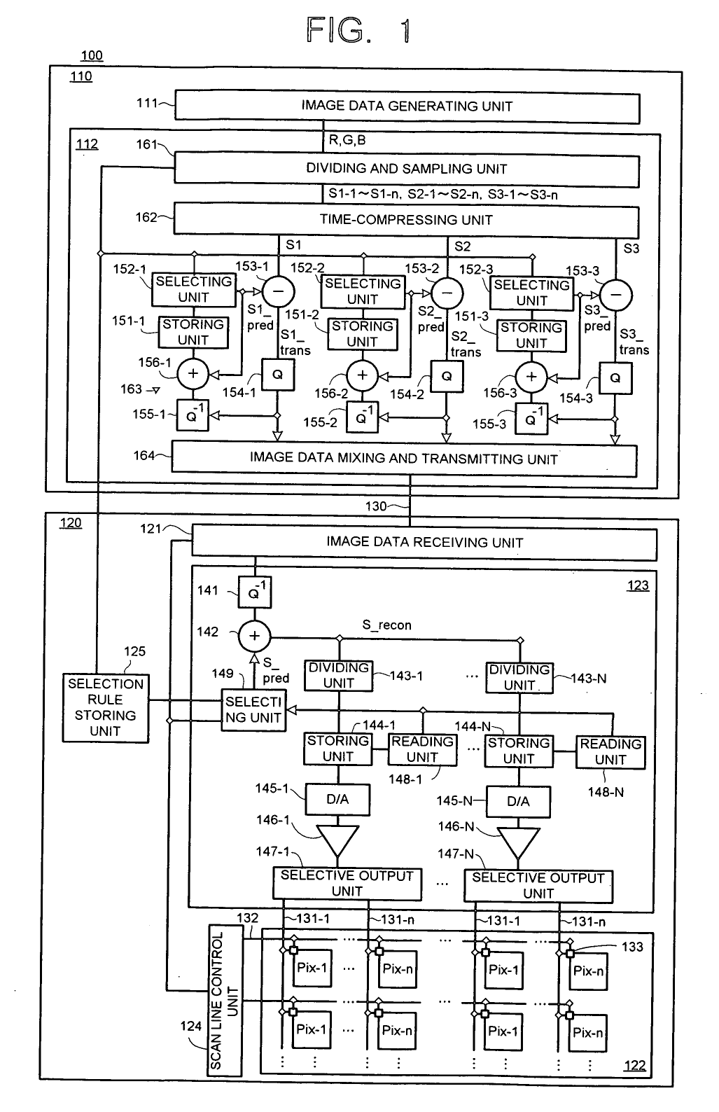

FIG. 1 is a block diagram representing a display system 100 according to a first embodiment of the present invention. The display system 100 has an image data transmitting device 110, an image data receiving device 120, and signal lines 131.

The image data transmitting device 110 is, for example, a computer, a television tuner, or the like which generates and transmits a differential signal for driving a display panel 122, and has an image data generating unit 111 and a differential data transmitting unit 112.

The image data receiving device 120 is, for example, a display module such as a liquid crystal display device which receives the differential signal from the image data transmitting device 110 and displays an image, and has an image data receiving unit 121, a display panel 122, a signal line control unit 123, a scan line control unit 124, and a selection rule storing unit 125.

The image data generating unit 111 generates and outputs image data for display on the display panel 122, in which means for generation is not taken into consideration and may be any one of, for example, a memory storing image data, a storage device such as a hard disk, a data input device which inputs image data, and a data reading device which reads image data from a storage medium or the like. Also, whether an image of the image data is a still image or a moving image is not taken into consideration.

The image data generating unit 111 outputs the generated image data in the form of signals R, G, B corresponding to display colors of red (R), green (G), blue (B). Note that the image data generating unit 111 may output signals Y, Pb, Pr or signals Y, CB, Cr instead of the signals R, G, B. For example, when the display panel 122 is a display for television, it may be driven by the signal Y, Pb (Cb), Pr (Cr). Also, even when the display panel 122 is driven by the signals R, G, B, the signals Y, Pb (Cb), Pr (Cr) may be converted into the signals R, G, B in advance. When the image data generating unit 111 outputs signals Y, Pb, Pr, substantially the same discussion may be effective by replacing “signals R, G, B” in the following description with “signals Y, Pb, Pr”

The differential data transmitting unit 112 differentiates image data between adjacent pixels displayed from the image data to generate differential data, and outputs these data. By employing the differential data as data (signal) to be transmitted, a change therebetween becomes small, so that EMI and power consumption can be decreased. Note that the differential data transmitting unit 112 transmits, in addition to the differential data (differential signal), a clock signal and a control signal (a scan line drive signal, a horizontal synchronizing signal, and the like) for controlling the display panel 122.

The image data receiving unit 121 receives differential data (a kind of image data) transmitted from the differential data transmitting unit 112. Instead of this, the image data receiving unit 121 may read image data stored in the differential data transmitting unit 112. It is satisfactory as long as the image data are transmitted as information from the differential data transmitting unit 112 to the image data receiving unit 121, and which of the differential data transmitting unit 112 and the image data receiving unit 121 proactively controls the transmission will not be a problem particularly.

The image data receiving unit 121 outputs the received differential signal and scan line control signal to the signal line control unit 123 and the scan line control unit 124, respectively.

The display panel 122 is a display such as a liquid crystal display device, which displays an image based on the clock signal, control signal, and image data. The display panel 122 has pixels Pix (Pix-1 to Pix-n), signal lines 131 (131-1 to 131-n), scan lines 132, and switching elements 133.

A pixel Pix is a basic unit to be driven by a switching element 133 for displaying an image. Color display is made possible by arranging, in a vertical-horizontal matrix form, pixels Pix displaying red (R), green (G), blue (B) respectively on the display panel 122. For example, pixels Pix (R) to Pix (B) corresponding to red (R), green (G), blue (B) are arranged in, for example, a stripe form on a scan line 132.

The pixels Pix are divided into a plurality of (N number of) blocks in which a group of a plurality of (n number, 2 to 5 for example, of) pixels Pix-1 to Pix-n is one block. Specifically, one scan line (horizontal line) 132 is divided into N number of blocks (regions), and in each block, n number of signal lines 131-1 to 131-n are serially (sequentially) switched in a chronological manner to display an image.

The signal lines 131 are wires outputting an image signal to the respective switching elements 133. As already described, the signal lines 131 are divided into N number of blocks with the n number of signal lines being one unit, and the image signal is switched and outputted to the n number of signal lines 131-1 to 131-n.

The scan lines 132 are wires outputting a control signal (scan line control signal) to the respective switching elements 133 for controlling ON/OFF thereof.

Each of the switching elements 133 is an element, for example a thin film transistor (TFT), for driving a pixel Pix to display.

The signal line control unit 123 controls the signal lines 131 based on image data outputted from the image data receiving unit 121. Incidentally, details thereof will be described later.

The scan line control unit 124 controls the scan lines 132 based on the scan line control signal outputted from the image data receiving unit 121.

The selection rule storing unit 125 is a storage device, a ROM (Read Only Memory) for example, which stores selection rules and sampling patterns (sampling orders: control orders of signal lines).

The selection rules indicate which adjacent pixel should be selected when image data of adjacent pixels Pix of the display panel 122 are differentiated. This is for transmitting the selection rules from the image data receiving device 120 to the image data transmitting device 110 so as to enable execution of optimum differentiation depending on the division of a block of pixels Pix and an order of switching output.

A data transmission line 130 is for transmitting signals (a clock signal, a control signal, image data) for driving the display panel 122.

(Details of the Differential Data Transmitting Unit 112)

The differential data transmitting unit 112 has a dividing and sampling unit 161, a time-compressing unit 162, a differential data generating unit 163, and an image data mixing and transmitting unit 164.

The dividing and sampling unit 161 divides and samples image data outputted from the image data generating unit 111. The dividing and the sampling correspond to dividing of one scan line 132 of the display panel 122 into the N number of blocks, and switching and driving of n number of pixels Pix-1 to Pix-n in these blocks. Specifically, the image data which are divided and sampled correspond to signals outputted to the pixels Pix-1 to Pix-n in the N number of blocks. In other words, the dividing and sampling unit 161 simulates a driving method of the display panel 122. This is for allowing the display panel 122 to readily process image data (differential data) outputted from the differential data transmitting unit 112 (reproduction of image data). Note that it is also possible to generate differential data on the differential data transmitting unit 112 side without simulating a driving state of the display panel 122.

With the scan line 132 being divided into the N number of blocks, sampling data outputted from the dividing and sampling unit 161 are outputted corresponding to the n number of pixels in these blocks. Specifically, image data corresponding to one scan line 132 are divided into n number of image data and outputted to every N number of pixels (N number of data are outputted n number of times).

The time-compressing unit 162 performs time-compression processing of sampling data outputted from the dividing and sampling unit 161. The sampling data outputted from the dividing and sampling unit 161 are thinned out, and thus they have gaps (time gaps) between data. By removing (time-compressing) these gaps, processing (generating differential data) in the differential data generating unit 163 is simplified.

The differential data generating unit 163 generates differential data from the time-compressed sampling data outputted from the time-compressing unit 162. The differential data generating unit 163 has storing units 151 (151-1 to 151-3), selecting units 152 (152-1 to 152-3), differential processing units 153 (153-1 to 153-3), quantizing units 154 (154-1 to 154-3), dequantizing units 155 (155-1 to 155-3), and adding units 156 (156-1 to 156-3).

Here, the storing units 151, selecting units 152, differential processing units 153, quantizing units 154, dequantizing units 155, and adding units 156 respectively constitute one group by three units. This corresponds to that the signals R, G, B outputted from the image data generating units 111 constitute one group by three signals (three colors). Differential data can be represented by a difference between different kinds of signals (for example, R-G, B-G), or by a difference between the same kinds of signals (for example, R1-R2, G1-G2, and the like). Therefore, by corresponding the storing units 151 and so on to the three signals respectively, generation of differential data is simplified, without depending on n number of divisions of image data (the number of pixels Pix to be selectively outputted).

The storing units 151 store the sampling data outputted from the differential data generating unit 163. Differential data outputted from the differential data generating unit 163 are quantized in the quantizing units 154. From these quantized differential data, image data are generated and stored in the storing units 151, so as to prevent mismatch (accumulation of quantization errors) of processing contents between the differential data generating unit 163 and the image data receiving device 120. Incidentally, details of this will be described later.

The selecting units 152 select image data suitable for subtraction in the differential processing units 153 from the stored image data in the storing units 151 based on the selection rules.

The differential processing units 153 subtract the image data selected by the selecting units 152 from image data outputted from the time-compressing unit 162 (differential processing) to generate differential data. As a result, change in signals transmitted in the data transmission line 130 is reduced.

The quantizing units 154 quantize differential data outputted from the differential processing units 153 (it is also referred to as “encoding”). Here, quantization refers to conversion of bits from, for example, 9 bits to 5 bits (reduction in the number of bits). Reducing the number of bits in a signal enables reduction in the number of signal lines and EMI in the data transmission line 130. This quantization can be performed using, for example, a quantization table which represents data before and after quantization in correspondence.

For this quantization, it is conceivable to apply nonlinear conversion. In differential data of adjacent pixels, usually a percentage for a value therein to be close to 0 (zero) is high. Then, according to this percentage, by converting one code when a percentage of occurrence is high or plural levels when the percentage is low into the same code, it is possible to reproduce a more accurate image even with the number of bits to be transmitted being reduced. For example, 0 (zero) is converted into 0 (zero) and 1 is converted into 1, but for a large difference, several codes are converted into the same number of codes in a combined manner such that 2 and 3 are converted into 2, and 4, 5 and 6 are converted into 3.

In the dequantizing units 155 and the adding units 156, the image data are reproduced based on differential data quantized in the quantizing units 156. This is for preventing that differential processing in the differential processing units 153 is different from processing in an adding unit 142 of the signal line control unit 123 which will be described later, due to the quantization in the quantizing units 154 (prevention of accumulation of quantization errors).

The dequantizing units 155 dequantize the differential data quantized in the quantizing units 154. This dequantization can be performed using, for example, a quantization table representing data before and after quantization in correspondence.

The adding units 156 reproduce the image data by adding differential data dequantized in the dequantizing units 155 and image data which are stored in the storing units 151 and correspond to these differential data.

The image data mixing and transmitting unit 164 mixes differential data outputted from the quantizing units 154-1 to 154-3 and transmits it to the image data receiving device 120 via the transmission cable 130. Instead of this transmission, writing to a storage device such as a video memory may be performed so as to allow the image data receiving unit 121 to perform reading from this storage device.

(Details of the Signal Line Control Unit 123)

The signal line control unit 123 has a dequantizing unit 141, an adding unit 142, dividing units 143 (143-1 to 143-N), storing units 144 (144-1 to 144-N), D/A converters 145 (145-1 to 145-N), amplifying units 146 (146-1 to 146-N), selective output units 147 (147-1 to 147-N), reading units 148 (148-1 to 148-N), and a selecting unit 149. Among them, the dividing units 143, the storing units 144, the D/A converters 145, the amplifying units 146, the selective output units 147, and the reading units 148 are disposed respectively in N number of groups corresponding to the N number of blocks on a scan line 132.

The dequantizing unit 141 dequantizes differential data outputted from the image data receiving unit 121. This dequantization can be performed using, for example, a quantization table representing data before and after quantization in correspondence. Since the dequantization is inverse conversion of quantization, differential data before being subjected to the quantization is generated by this dequantization. However, since the number of bits before and after the quantization is different, the differential data dequantized in the dequantizing unit 141 may be different to a certain degree from differential data before being subjected to the quantization in the quantizing units 154.

The adding unit 142 adds differential data outputted from the dequantizing unit 141 and image data selected in the selecting unit 149 to reproduce original image data before being subjected to the differential processing in the differential processing units 153.

The dividing units 143 divide image data outputted from the adding unit 142 so as to correspond to the N number of blocks on a scan line 132 to generate image data for every pixel, and write them in the storing units 144.

The storing units 144 store (retain) the image data written by the dividing units 143.

The D/A converting units 145 convert digital image data stored in the storing units 144 into analog voltages and the like and output them.

The amplifying units 146 amplify the output such as a voltage or the like from the D/A converting units 145.

The selective output units 147 are ones, switches using a p-Si (polysilicon) for example, which output signal line drive signals outputted from the D/A converting units 145 to the n number of signal lines 131-1 to 131-n in a switching manner.

The reading units 148 read out the image data stored in the storing units 144.

The selecting unit 149 selects image data read out by the reading units 148 and outputs them to the adding unit 142. This selection is based on the selection rules stored in the selection rule storing unit 125.

(Operation of the Display System 100)

Hereinafter, operation of the display system 100 being divided for the image data transmitting device 110 and for the image data receiving device 120 will be described.

A. Operation on the Image Data Transmitting Device 110 Side

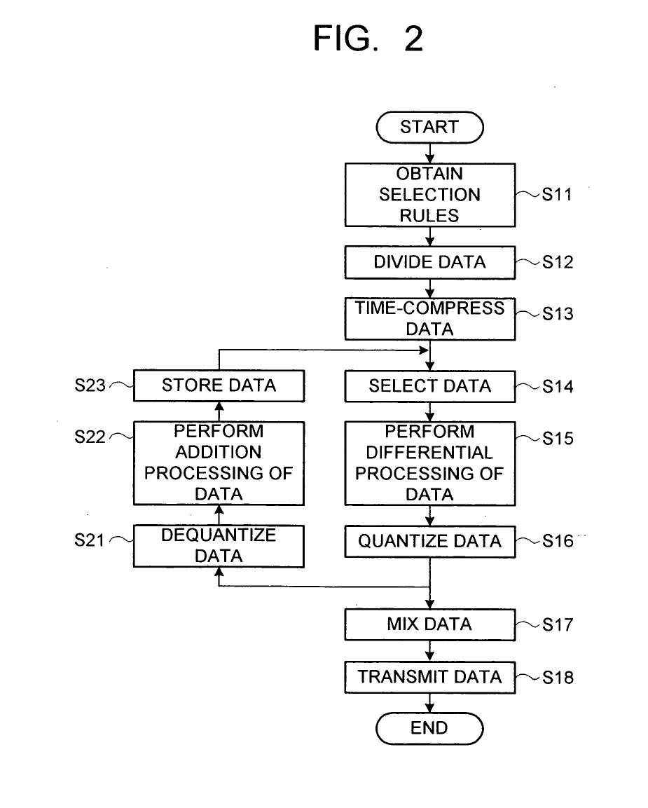

FIG. 2 is a flowchart representing an example of an operation procedure of the image data transmitting device 110.

(1) Obtaining Selection Rules (Step S11)

The image data transmitting device 110 obtains (for example, reads, receives) selection rules and a sampling pattern stored in the selection rule storing units 125. If the obtained selection rules and sampling pattern are stored in a memory or the like, the later processing becomes easy.

(2) Dividing Image Data (Step S12)

Based on the sampling pattern, dividing and sampling of image data are performed. Image signals of R, G, B are sampled by 1/n in sampling blocks 1 to n respectively. When the image signals are XGA signals, there are 1024 pixels Pix horizontally (on a scan line 132), which are divided into n number of signals, R1 to Rn, G1 to Gn, and B1 to Bn. According to the sampling pattern, the image data are sampled to be suitable for a difference between adjacent pixels, and signals on one scan line 132 are divided respectively into n number of signals, S1-1 to S1-n, S2-1 to S2-n, and S3-1 to S3-n.

(3) Time-Compressing Image Data (Step S13)

The sampled image data G (x, y) is time-compressed by 1/n and combined into S1, S2, S3 respectively in the order of S1-1 to S1-n, S2-1 to S2-n, S3-1 to S3-n, and thus 3*n number of signals become three signals.

(4) Selecting Image Data (Step S14)

Data of pixels adjacent to pixels of image data to be transmitted are selected from the sampled image data. The selected image data are designated as predicted pixel values S_pred (S1_pred to S3_pred). This selection is made based on the selection rules. In the selection rules, basically, image data are selected in accordance with the following criteria 1) and 2).

1) A pixel that is not separated from more than one pixel in the vertical and the horizontal direction of an image

2) A pixel having the same color

Since data of adjacent pixels tend to be approximate, selecting pixels and taking a difference in this manner can reduce the amount of data to be transmitted. Among them, 1) is an almost essential condition but 2) is not essential, and therefore adjacent pixels may be selected so as to satisfy it as far as possible. Incidentally, details of the selection rules will be described later.

(5) Performing Differential Processing of Image Data (Step S15)

Differences are taken between the selected predicted pixel values S_pred (S1_pred to S3_pred) and pixel values S (S1 to S3) to be transmitted, thereby calculating transmission signals S_trans (S1_trans to S3_trans). Differences of the signals S1 to S3 which have become three signals from the most adjacent pixels are taken and transmitted as the transmission signals S_trans, namely, differential signals.

(6) Quantizing Image Data (Step S16)

The transmission signals S_trans are quantized, which are designated as D(x, y). The quantization of image data is conversion of bits, in which the number of bits of data is reduced from, for example, 8 bits to 5 bits. This quantization can be performed using a quantization table which represents data before and after quantization in correspondence.

(7) Performing Prevention Processing of Accumulation of Quantization Errors (Steps S21 to S23)

It is conceivable that using data before being subjected to quantization for differential processing in Step S15 and transmitting differential data after being subjected to the quantization can cause errors in reproduction of image data on the image data receiving device 120 side. In other words, it is conceivable that a quantization error occurs due to a difference of the number of bits before and after the quantization, and differences in values become large between differential processing on the transmitting side and dequantization and addition processing (reproduction processing) on the receiving side (accumulation of quantization errors).

Here, in order to prevent the accumulation of quantization errors, the same reproduction data as that on the receiving side is used for the differential processing in Step S15. Specifically, also on the transmitting side, similarly to the receiving side, quantized differential signals are dequantized and added to reproduction data stored in the storing units 151 to thereby reproduce image data.

These reproduced image data are stored in the storing units 151, and data of adjacent pixels are selected therefrom and used for differential processing. Image data reproduced from once quantized image data, namely, the same image data as those in reproduction signal processing on the receiving side are used to perform the differential processing. Accordingly, quantization errors are not accumulated, so that appropriate differential data can be generated.

(8) Mixing and Transmitting Image Data (Steps S17, S18)

The quantized transmission signals S_trans are mixed to generate mixed image data D(x,y). This mixing can also be performed by writing them into a video memory for example.

Mixed image data are transmitted. For example, differential signals written into the video memory are read out and transmitted synchronously with scan control of the display panel 122 of the image data receiving device 120. Display image signals R, G, B are transferred by a clock CK that is synchronized with a horizontal synchronizing signal HSYNC.

By transmitting the differential signals instead of the image data, it is possible to reduce electromagnetic radiation intensity, power consumption, and the like.

B. Operation on the Image Data Receiving Device 120 Side

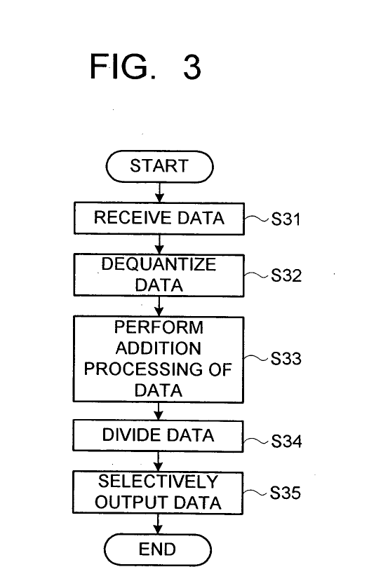

FIG. 3 is a flowchart representing an example of an operation procedure of the image data receiving device 120.

(1) Receiving Image Data (Step S31)

Image data transmitted from the image data transmitting device 110 is received in the image data receiving device 120. For example, differential signals written in a video memory are read out and transmitted synchronously with scan control of the display panel 122 of the image data receiving device 120.

(2) Performing Dequantizing and Addition Processing of Image Data (Steps S32 and S33)

Differential data transmitted to the receiving side are dequantized using a quantization table or the like.

By adding the predicted pixel values (predicted signals) S_pred, which are selected from the storing units 144 according to the sampling pattern, to the dequantized differential data, a reproduction signal S_recon is generated. In other words, according to the sampling pattern, the predicted signals S_pred are selected from signals for one previous divided line stored in the storing units 144 via the reading units 148 and added to the transmission differential signals S_trans.

(3) Dividing and Selectively Outputting Image Data (Steps S34, S35)

The generated reproduction signal S_recon is divided into N number of blocks on a scan line 132. The divided image data are stored in the storing units 144, D/A converted in the D/A converters 145, amplified in the amplifying units 146, and selectively outputted to one of the signal lines 131-1 to 131-n by the selective output units 147.

The above steps S31 to S35 are repeated.

C. Relationship Between the Sampling Patterns and the Selection Rules

The sampling patterns will be described specifically with respect to the cases where the number of divisions is 2 to 5.

(1) A Sampling Pattern and Selection Rules for the Case where the Number of Divisions is 2

A sampling pattern and selection rules for the case where the number n of divisions is 2 will be described. As the display panel 122, it is assumed the case where pairs of every two pixels are sectioned as blocks in a vertical stripe arrangement of red (R), green (G), blue (B). At this time, two patterns 1, 2 are shown.

-Pattern 1

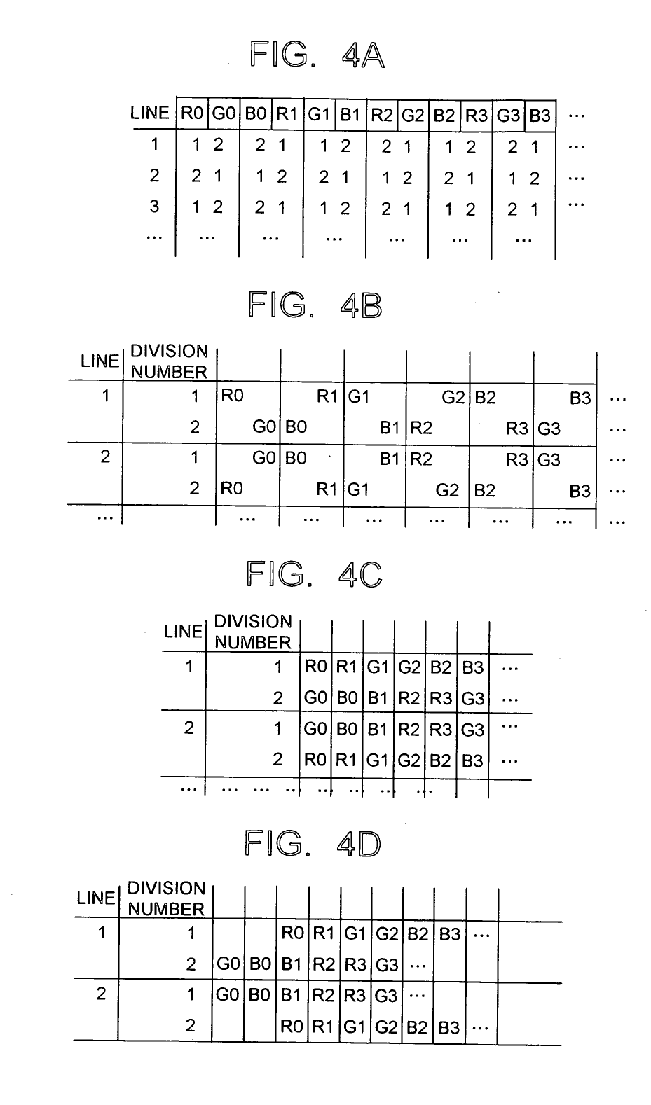

FIG. 4A to FIG. 4D are schematic diagrams showing examples of a selection order (sampling pattern) of pixels, divided and sampled image data, time-compressed image data, and selection rules (pattern 1), respectively, for the case where the number of divisions is 2.

In FIG. 4A, sets of pixels divided by every two such that RG, BR, GB, RG and so on show blocks which can be controlled by the selective output units 147. Also, the number of divisions indicates an order of pixels to be selected when time-divided driving is performed within one line, and in the case of two divisions, one scan line 132 is divided to be driven two separate times. In this example, in the leftmost block, the pixels R0, G0 are selected in order.

The selection rules are based on the following three principles regardless of the number of divisions:

Principle 1) The same color is selected in the same block sequentially

Principle 2) If the same color does not exist, the same color is selected from the next block

Principle 3) All of the same colors are selected on one line (especially a multiple of 3)

For example, when the red pixel R0 is selected on the first line (first scan line), Principle 1) is not applicable, so that the red pixel R1 in the next block is selected according to Principle 2). For the red pixel R1, the green pixel G1 is selected because a red pixel does not exist in the next block. For the green pixel G1, the green pixel G2 is selected according to Principle 2) because the green pixel exists in the next block.

Selection rules for the pattern 1 shown in FIG. 4D are as follows.

For the pixel R0 of the division number 1 on the first line, since there is no other pixel, a difference from 128 levels (predetermined dummy data) as an intermediate image is taken. Besides that, a difference from pixels in the horizontal direction is taken, such as “R1-R0” for the pixel R1 and “G1-R1” for the pixel G1.

For the division number 2 on the first line, two pixels are shifted leftward and a vertical difference (difference between pixels which are arranged in the vertical direction) and a horizontal difference (difference between pixels which are arranged in the horizontal direction) are used together, so that a difference from an adjacent pixel of the same color can be taken within one pixel. Specifically, for the pixel R2, a vertical difference from the pixel R1, “R2-R1” is taken, and for the pixel R3, a horizontal difference from the pixel R2, “R3-R2” is taken. Also, for the pixel G3, a vertical difference from the pixel G2, “G3-G2” is taken, and for the pixel G4, a horizontal difference from the pixel G3, “G4-G3” is taken. Thus, a difference of the same color can be taken within one pixel.

For the division number 1 on the second line, a vertical difference can be taken with no shift from the previous one, which increases the correlation.

If the second line is transmitted in the same order as that for the first line, for signal transmission of the pixel R1 the pixel R2 located obliquely upward must be used, so that the correlation thereof becomes lower than that with one horizontal or vertical pixel. This problem can be solved by inverting the order of transmission for every line.

It is assume that the order of transmission for the second line is the same as that for the first line. In this case, using a signal of the pixel R2 reproduced on the first line to reproduce a signal of the pixel R1 reproduced on the second line is utilization of the pixels R1, R2 which have the same color and are most adjacent to each other. However, the pixel R2 on the first line and the pixel R1 on the second line are arranged obliquely, and thus the distance therebetween is 2^{1/2} times larger as compared to the case of the vertical and horizontal arrangement. Thus, correlation between the signals of the pixels R1, R2 is decreased.

On the contrary, when the order of transmission for the second line is inverted with respect to that for the first line, for signal reproduction of the pixel R2 in the division number 1 on the second line, a signal of the pixel R2 in the division number 2 on the first line, namely, a pixel that is adjacent in the vertical direction can be used. Thus, the reduction in correlation between the signals of the pixels R2 can be suppressed. Also, for signal reproduction of the pixel R1 in the division number 2 on the second line, the signal of the pixel R2 that is adjacent in the horizontal direction can be used, so that it is not necessary to use an oblique pixel for the signal reproduction of the pixel R1.

-Pattern 2

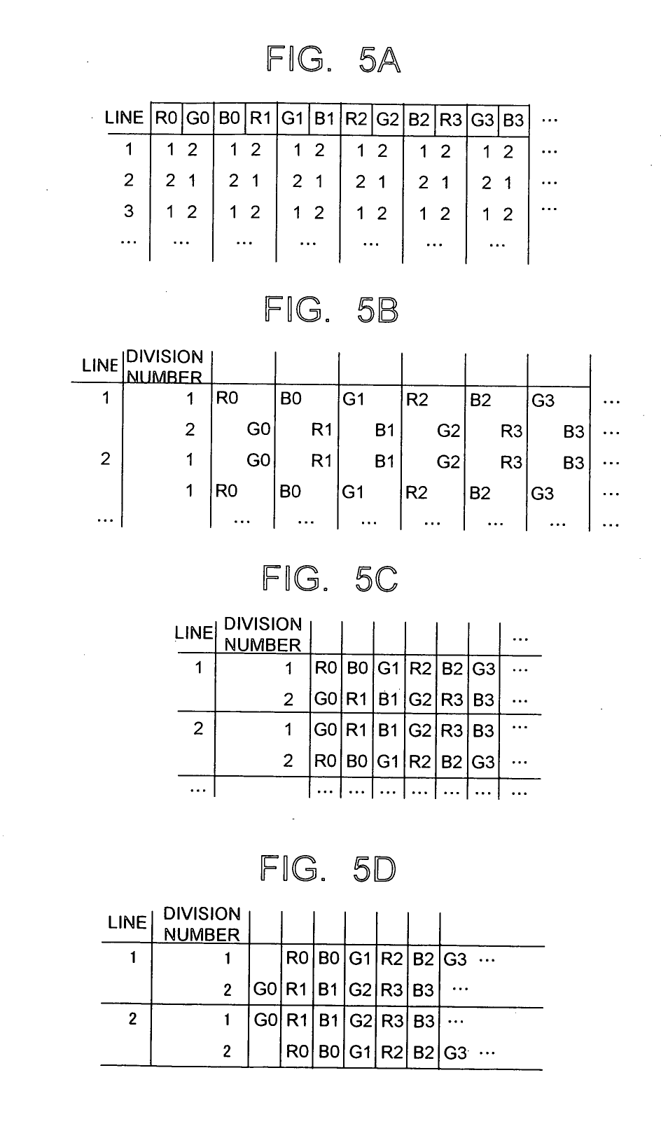

FIG. 5A to FIG. 5D are schematic diagrams showing a selection order (sampling pattern) of pixels, divided and sampled image data, time-compressed image data, and selection rules, respectively, for the case of the pattern 2 where the number of divisions is 2.

The pattern 2 is an exception. Specifically, for the case of two divisions where Principles 1) to 3) are not effective, there exceptionally exists only one pattern that is capable of sampling R, G and B sequentially at exactly the same interval.

As shown in FIG. 5A to FIG. 5D, in the pattern 2, a difference within one pixel can be taken.

-Changing the Selection Order for Pixels Pix

In the above patterns 1, 2, the selection order for pixels Pix is inverted for every horizontal line. This reduces visibility of vertical stripe variations by shifting them for every horizontal line.

When the signal lines 131 are selectively driven sequentially by the selective output units 147, a difference may occur in driving conditions, such as a time for driving, depending on what order the signal lines 131 are driven. For example, on a signal line 131 that is driven first, ⅓ of a horizontal scan period 1H is driven by the output from the selective output units 147, but ⅔ thereafter may be driven by a charge stored in capacity of the signal line 131. On the other hand, on a signal line 131 that is driven at last, ⅔ of the horizontal scan period 1H is driven by a previously driven signal, and only for the last ⅓ period, an original signal is supplied from the selective output units 147.

As above, there is a possibility that dispersion occurs in signals written into each pixel Pix and appears as vertical stripe variations.

By inverting the order for every horizontal line, visibility of this variation can be improved. Specifically, a position of variation displaces on every line, so that the vertical stripes that become variations are very difficult to see.

In these patterns 1, 2, the order is completely inverted, but changing the order can also achieve the same effect, so that the order may be changed on every line or every plural lines.

(2) Sampling Patterns for the Case where the Number of Divisions is 3

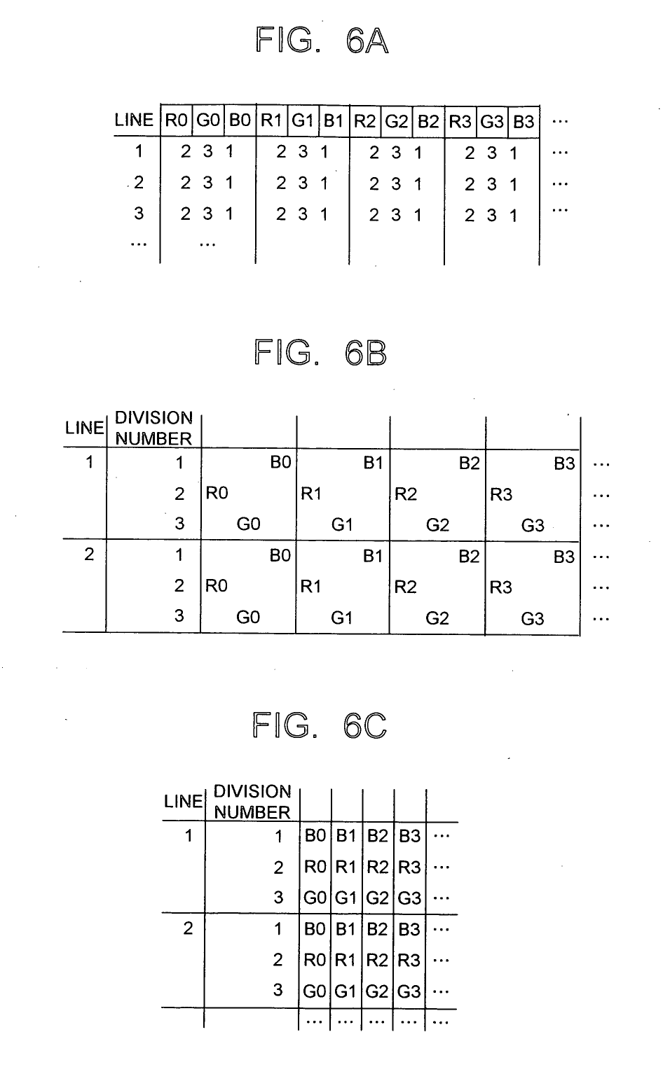

FIG. 6A to FIG. 6C are schematic diagrams showing a selection order (sampling pattern) of pixels, divided and sampled image data, and time-compressed image data, respectively, for the case where the number of divisions is 3.

Principle 3) is applicable to the sampling pattern for this case, and thus there are pixels of the same color in every division. Accordingly, when seen from a time-compressed G(x, y) space, colors in the vertical direction are different, and therefore reproduction is performed mostly using horizontal correlation.

Incidentally, if there are many achromatic images, correlations regarding R-G, B-G, R-B are high. Also, similarly to a second embodiment which will be described later, it is also conceivable that both vertical and horizontal patterns are prepared, and differences thereof are compared so as to change the selecting method.

(3) Sampling Patterns for the Case where the Number of Divisions is 4

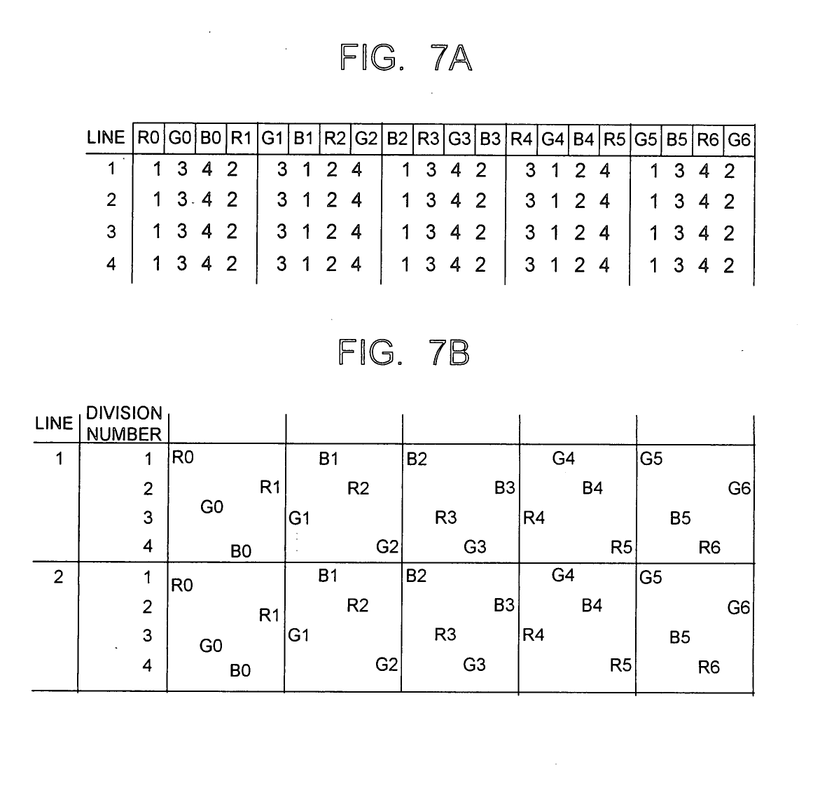

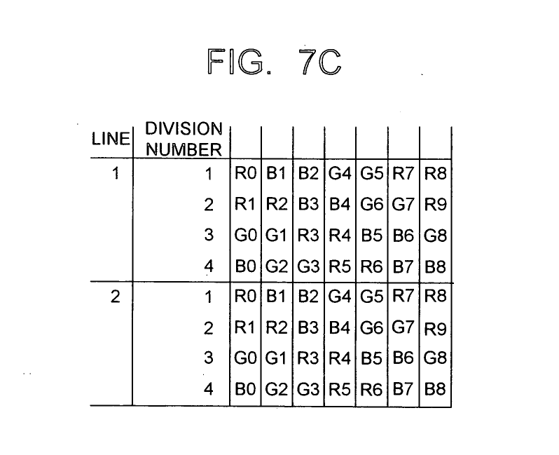

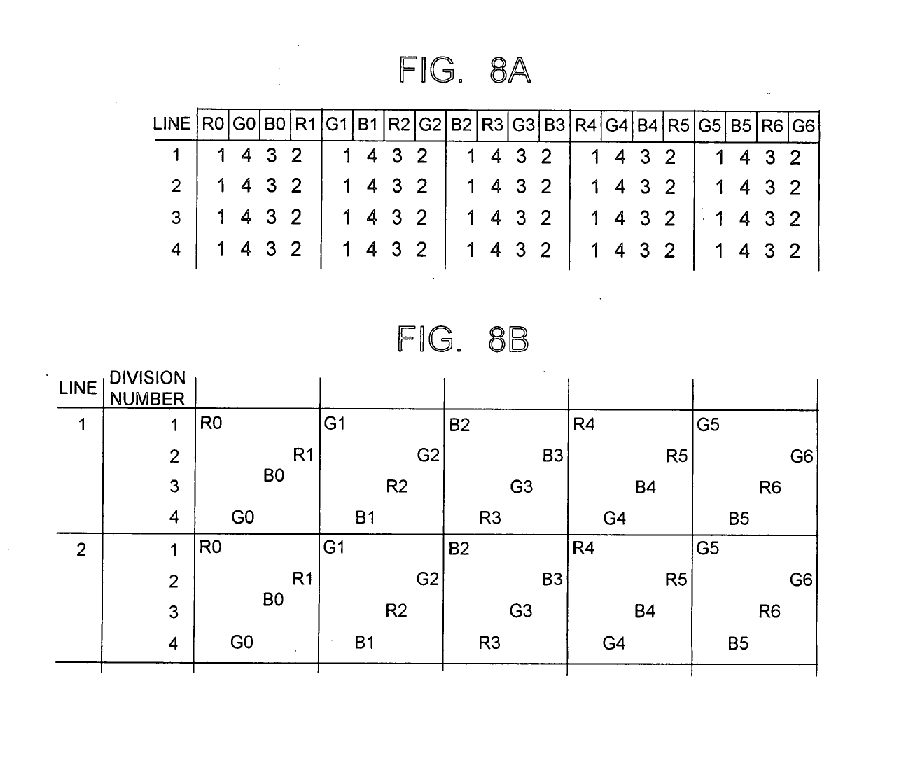

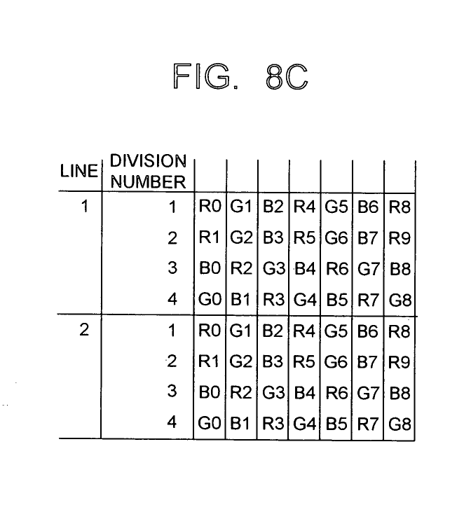

FIG. 7A to FIG. 7C and FIG. 8A to FIG. 8C are schematic diagrams showing selection orders (sampling patterns), divided and sampled image data, and time-compressed image data for the cases of the patterns 1, 2 where the number of divisions is 4, respectively.

In the pattern 1, according to Principle 1), in a same block on the first division number 1, the pixel R0 is selected and on the next division number 2, the same color as the pixel R1 is selected sequentially. On the third one, the same color does not exist in the same block, so that the pixel B0 is selected in the same block, and the pixel R2 of the same color is selected in an adjacent block. Next, a pixel of the same color does not exist in the same block and therefore the pixel G0 is selected, and in the adjacent block, a pixel of the same color does not exist and therefore the pixel R4 of the same color in an adjacent block is selected. For the other colors, selection is made in the same manner.

The pattern 2 is the case where the same color is selected in a same block in the order of pixels R0, R1, and when the pixel R1 is selected, the pixel R2 of the same color is selected at the same time in an adjacent block according to Principle 2). Thus, since there are several principles, sampling patterns can be created in various patterns.

(4) Sampling Patterns for the Case where the Number of Divisions is 5

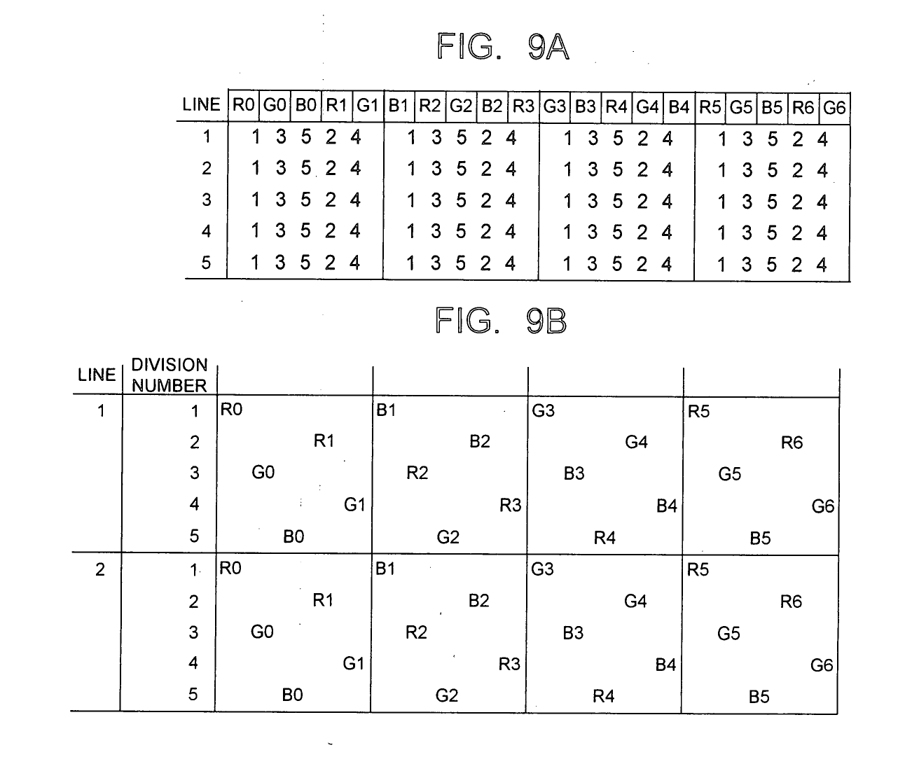

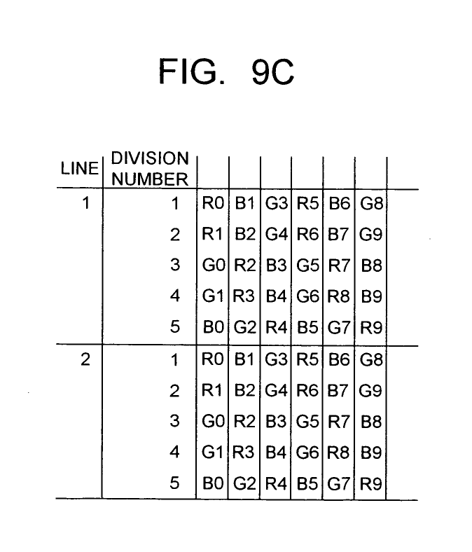

FIG. 9A to FIG. 9C are schematic diagrams showing a selection order (sampling pattern) of pixels, divided and sampled image data, and time-compressed image data, respectively, for the case where the number of divisions is 5.

According to Principle 1), the same colors are selected sequentially in a same block in the order of pixels R0, R1, and in the next division number 3, the same color does not exist and thus the pixel R2 of the same color is selected from an adjacent block according to Principle 2).

According to Principle 2), even with the 5 number of divisions, a difference from an adjacent pixel within one pixel can be taken constantly, as shown by the time-compressed image G(x, y).

(5) Comparison Example

When a scan line 132 is divided into blocks, an image to be stored in the storing units 151 is not of the image data for a previous scan line but of image data divided on the scan line 132. Accordingly, when the image is divided simply, correlation between divided images with each other becomes low, and therefore when they are transmitted as differential signals, variation thereof becomes large, which may result in that EMI and power consumption not being reduced.

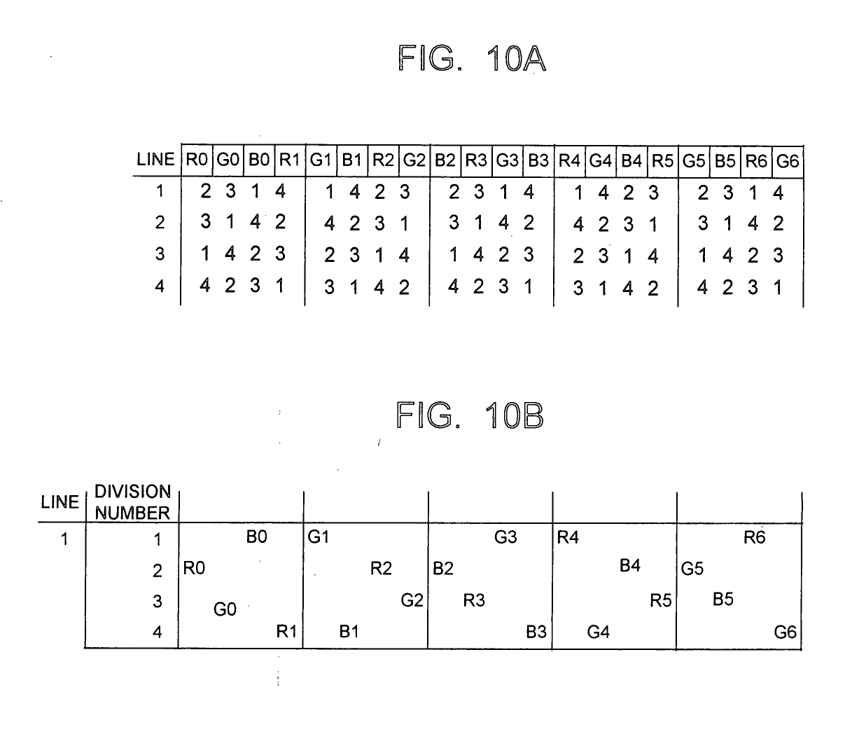

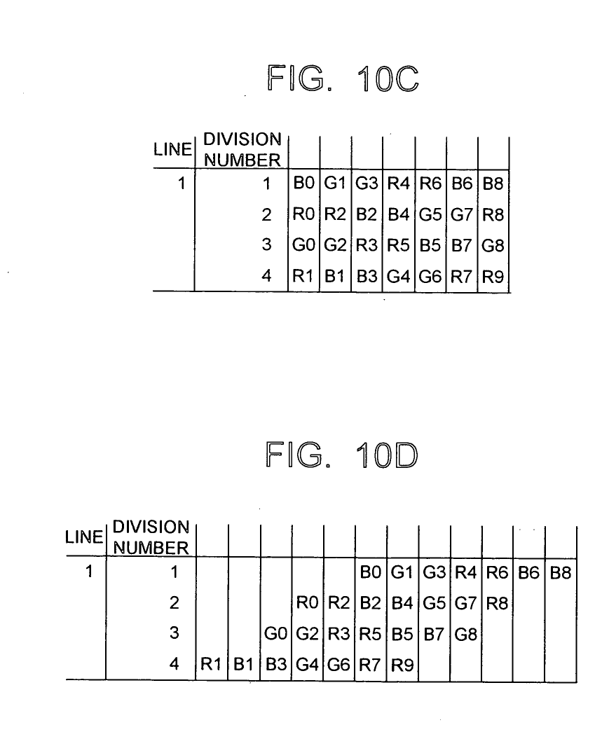

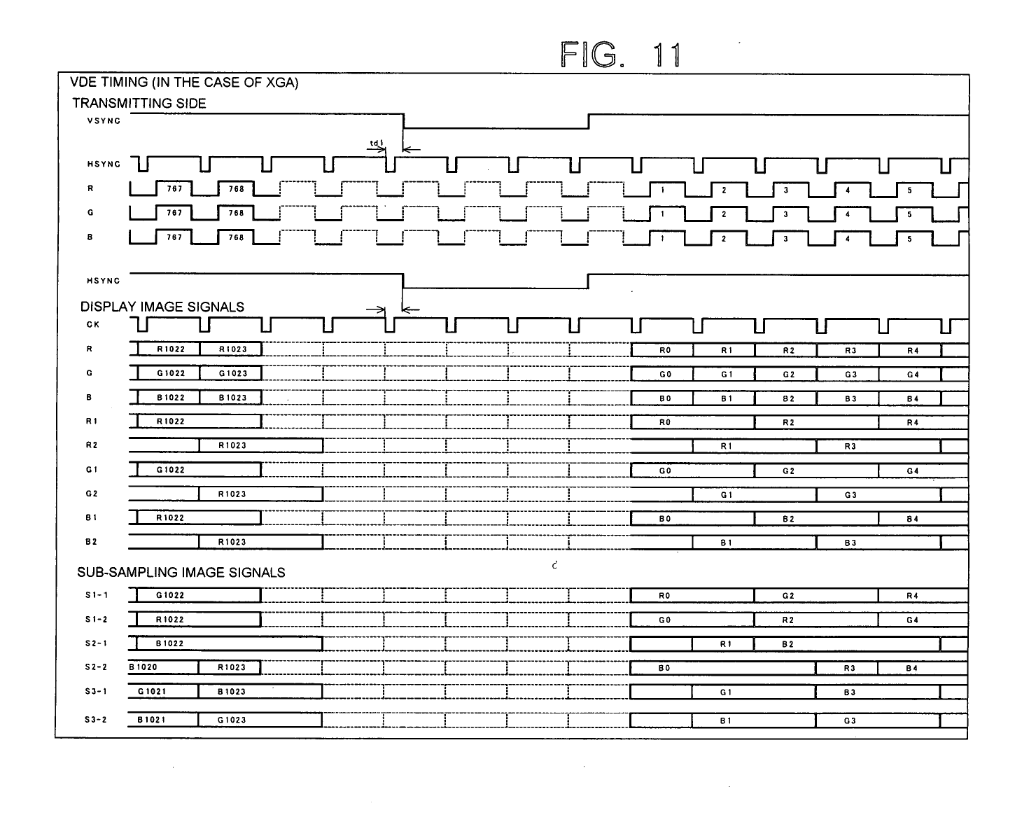

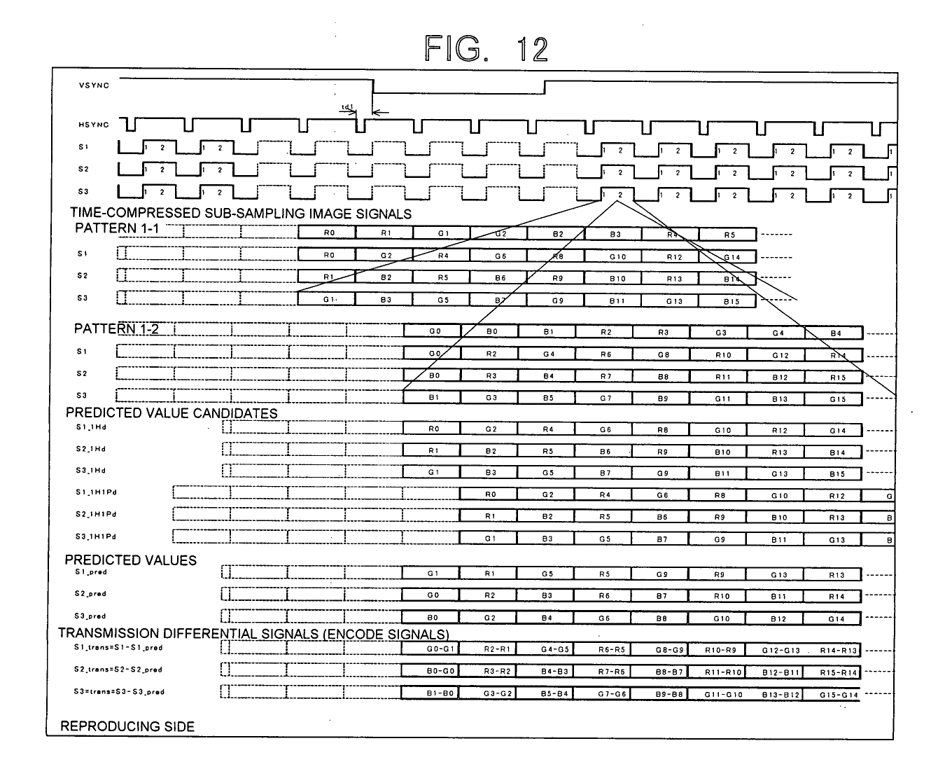

FIG. 10A to FIG. 10D are schematic diagrams showing examples of a selection order (sampling pattern) of pixels, divided and sampled image data, time-compressed image data, and selection rules for the case where the number of divisions is 4.

When a difference in the vertical direction is taken in this pattern, as shown in FIG. 10D, a signal on a previous line is shifted by two pixels to take each difference. As a result, a difference from a pixel that is two pixels away is transmitted, so that the correlation thereof becomes low.

D. Timing Charts

The sampling patterns will be described specifically with respect to the cases where the number of divisions is 2 to 5.

(1) The Case of 2 Number of Divisions

FIG. 11 to FIG. 13 are views showing timing charts for the 2 number of divisions.

In display image signals R, G, B transmitted by the clock CK that is synchronized with the horizontal synchronizing signal HSYNC, in the case of an XGA signal, horizontally there are 1024 pixels, which are divided respectively into two signals, R1, R2, G1, G2, B1, B2.

Here, a sampling pattern should be transmitted in the order shown by patterns 1-1 and 1-2 in FIG. 12, and corresponding to them, sampling is performed as S1-1, S1-2, S2-1, S2-2, S3-1, S3-2. Specifically, the patterns 1-1 and 1-2 of S1 in FIG. 12 are made to correspond to S1-1 and S1-2 in FIG. 11 respectively, and the patterns 1-1 and 1-2 of S2 are made to correspond to S2-1 and S2-2 respectively.

When the thus sampled S1-1 and S1-2 are time-compressed to ½ and rearranged in the order of S1-1, S1-2, they become S1 in FIG. 12. Thereafter, the same applies to S2, S3.

A predicted signal S1_pred is selected from an S1_1Hd that is delayed by one vertical pixel and an S1_1H1Pd that is delayed further by one pixel according to a registered sampling pattern. This sampling pattern complies the following conditions 1), 2).

1) An adjacent pixel within one pixel

2) The same color

A difference from the thus selected predicted value S1_pred, S1-S1_pred is transmitted as an S1_trans. Note that the same applies to the signals S2, S3.

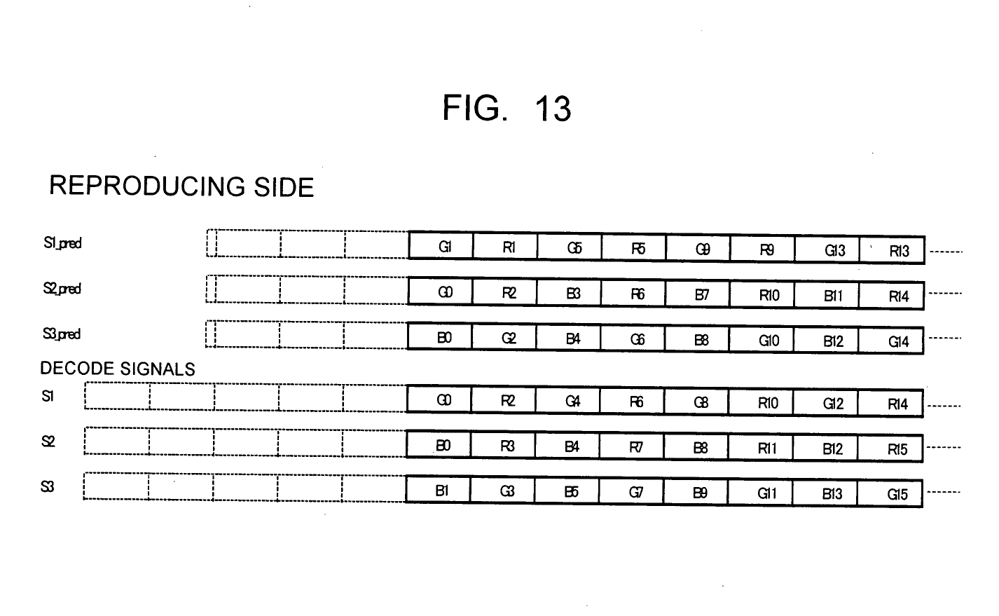

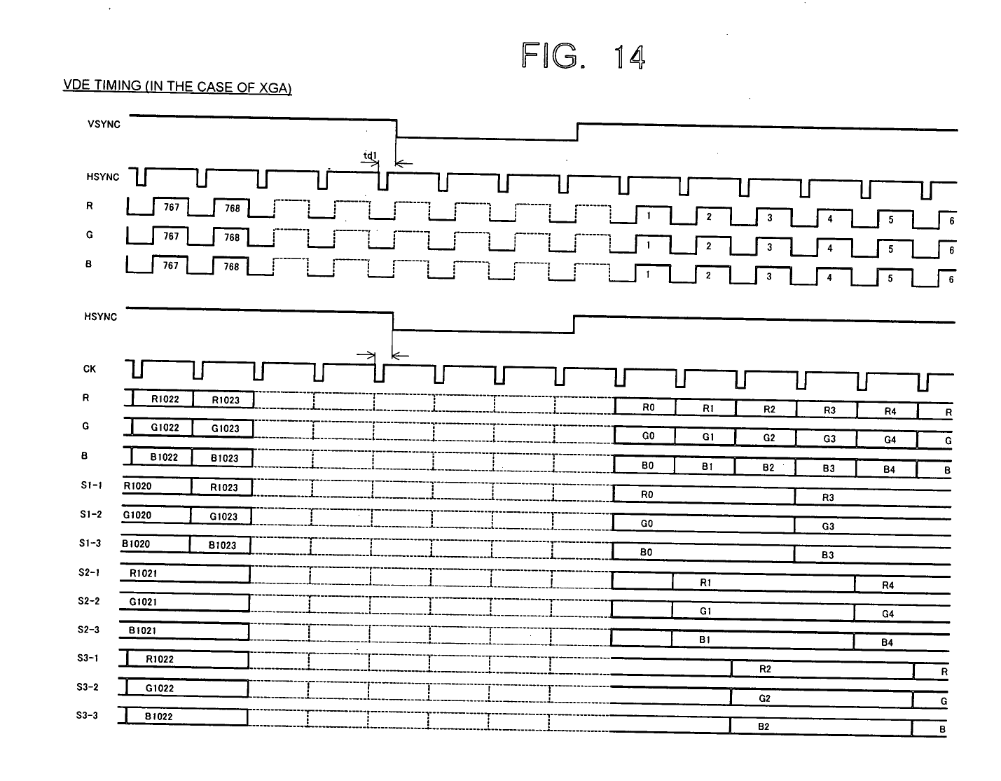

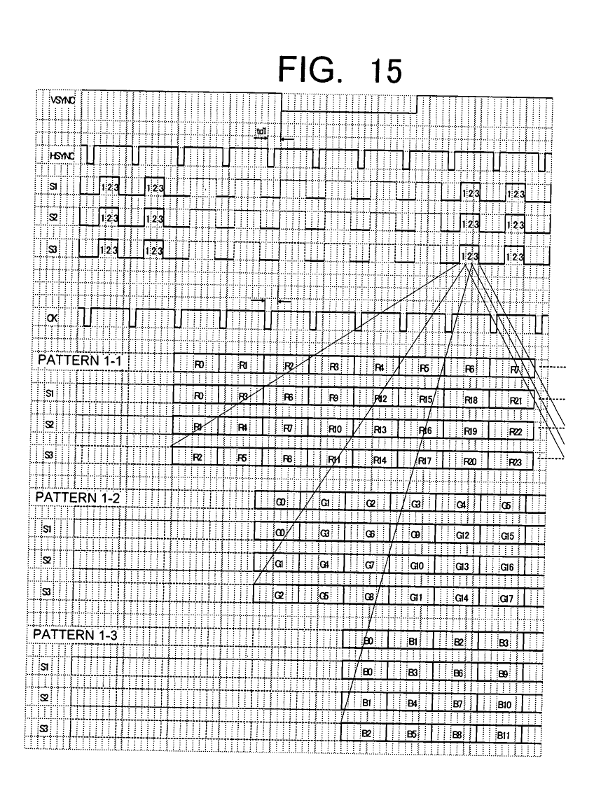

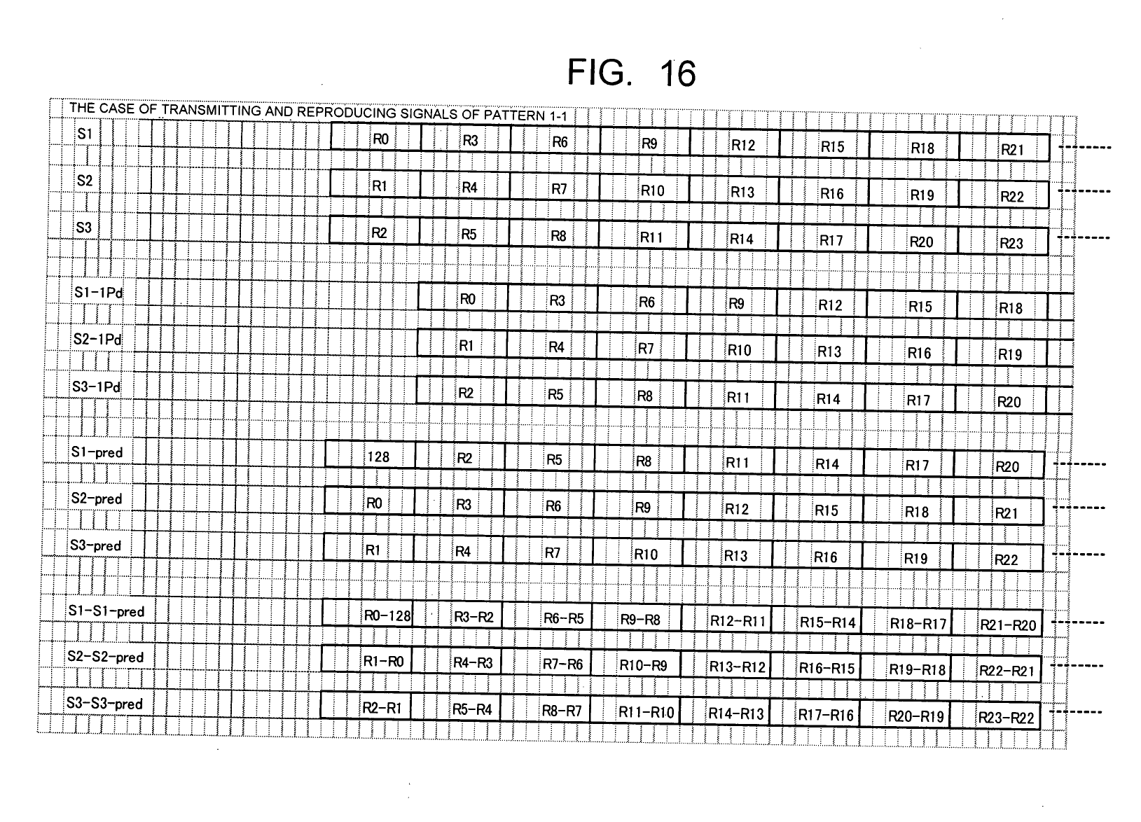

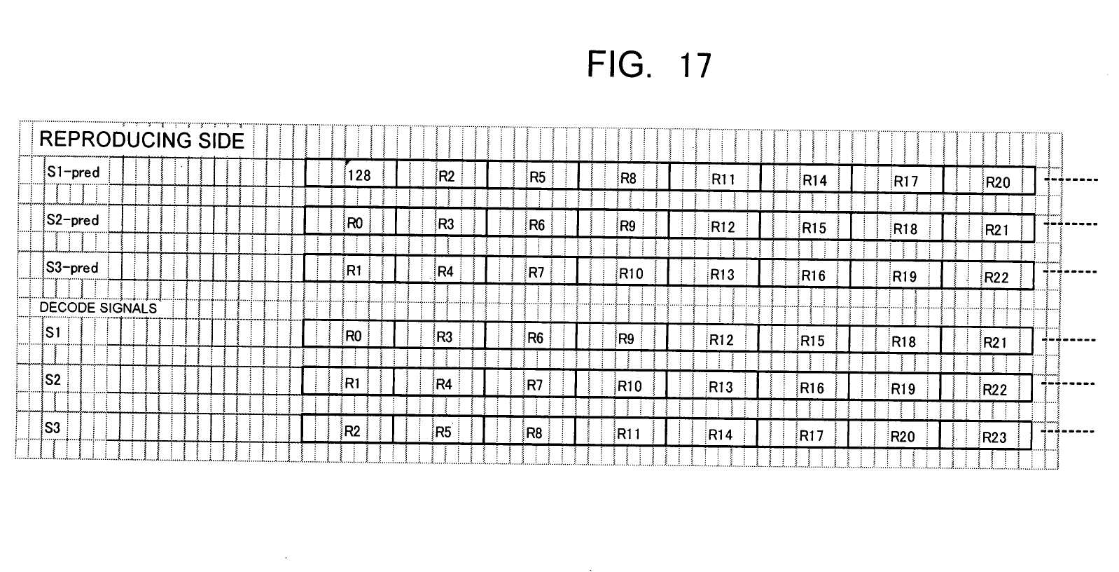

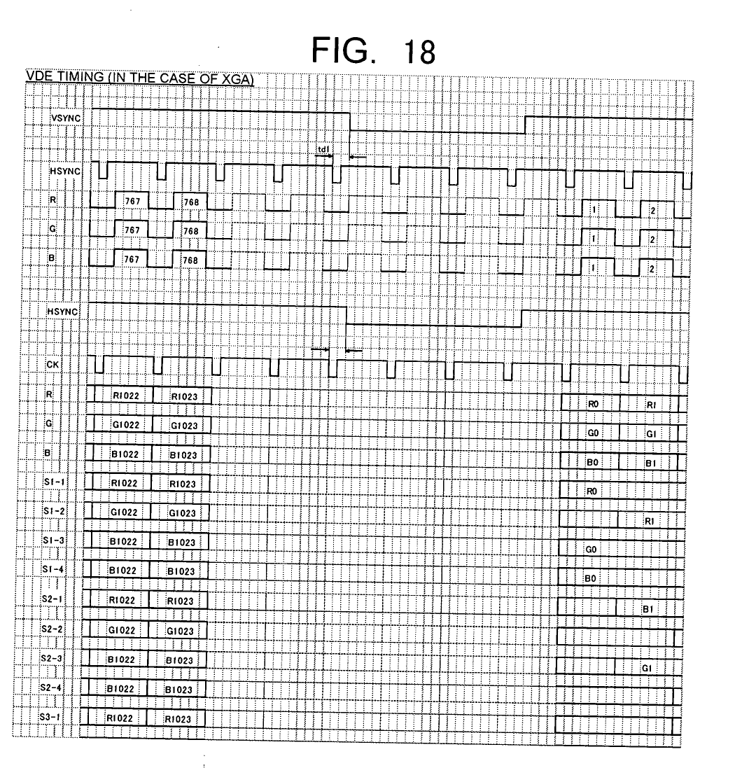

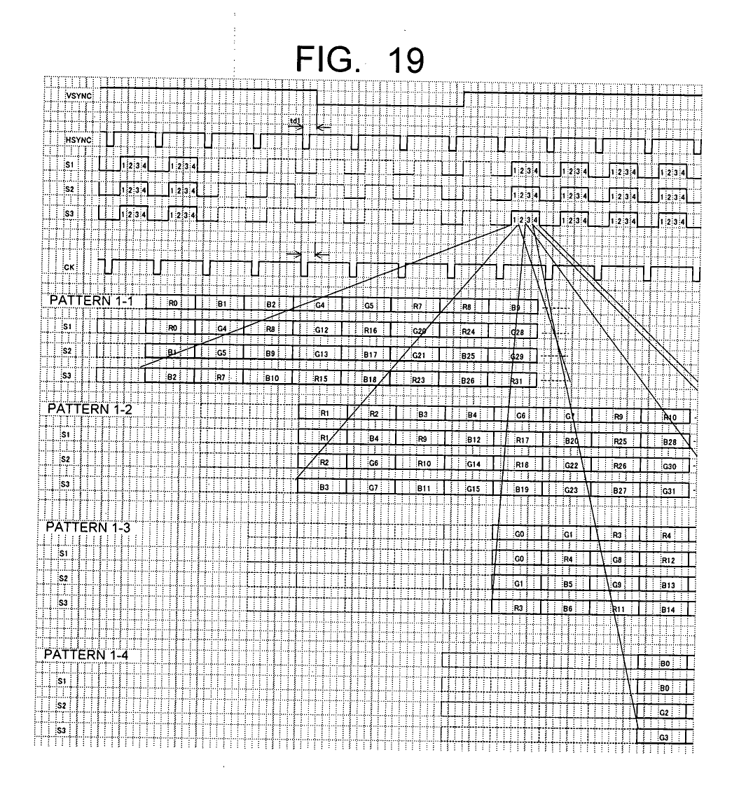

As shown in FIG. 13, when reproducing, a predicted signal S1_pred, which is determined in the same manner as the receiving side, is created on the reproducing side and added to the transmission signal S1_trans to obtain a reproduction signal S_recon.

(2) The Cases of 3 to 5 Number of Divisions

FIG. 14 to FIG. 17 are views showing timing charts for the 3 number of divisions. Note that the sampling pattern in this case is shown in FIG. 6A to FIG. 6C.

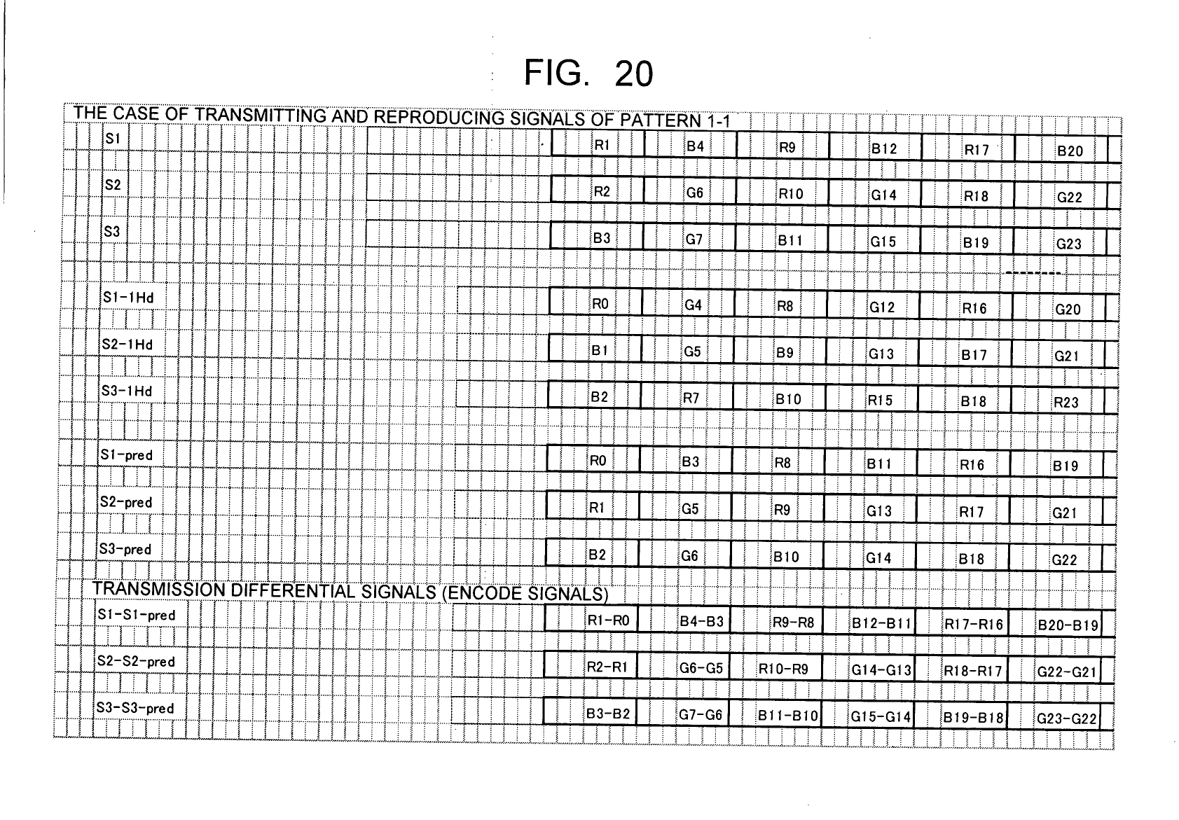

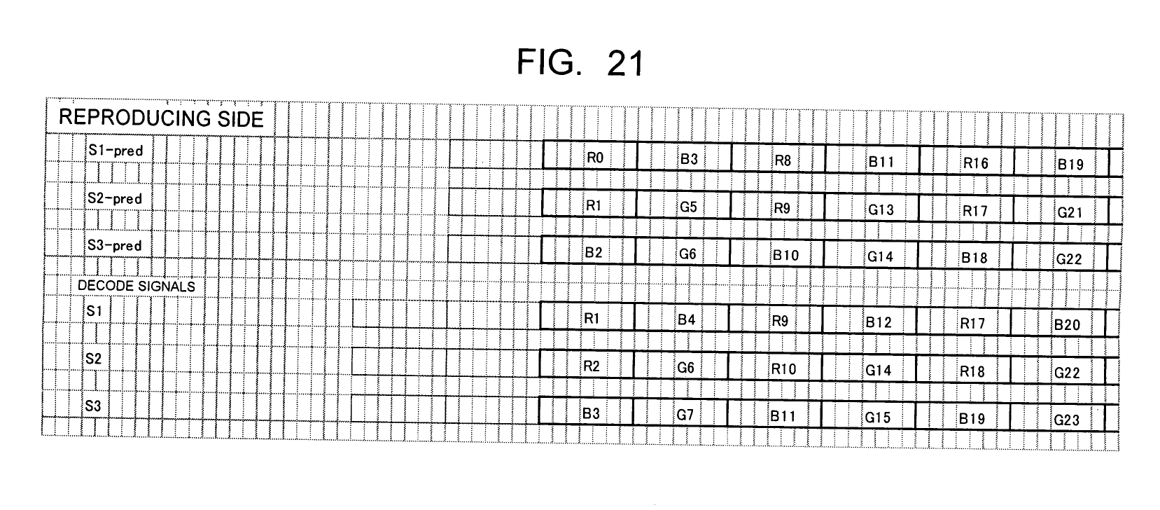

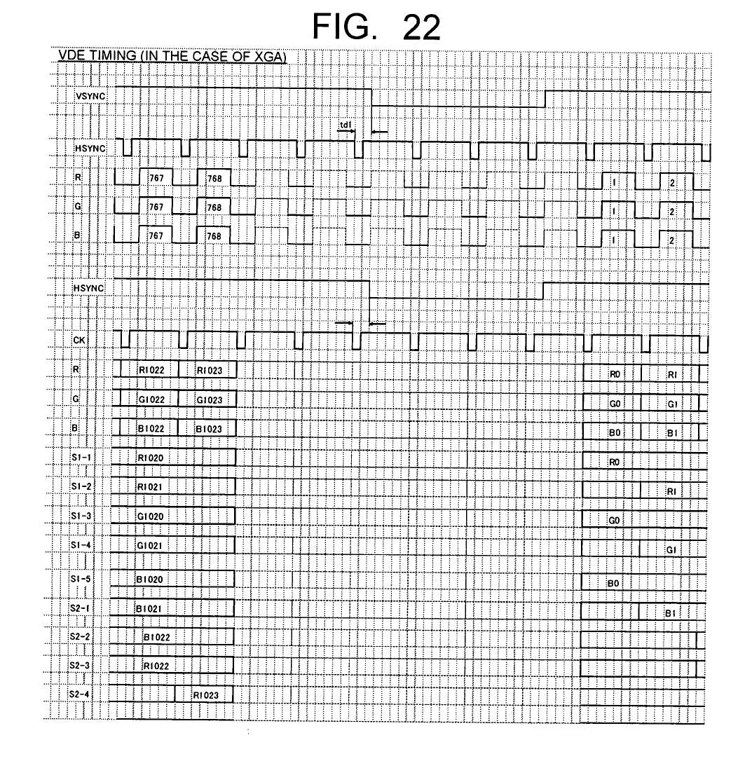

FIG. 18 to FIG. 21 are views showing timing charts for the 4 number of divisions. Note that the sampling pattern in this case is shown in the pattern 1 (FIG. 7A to FIG. 7C).

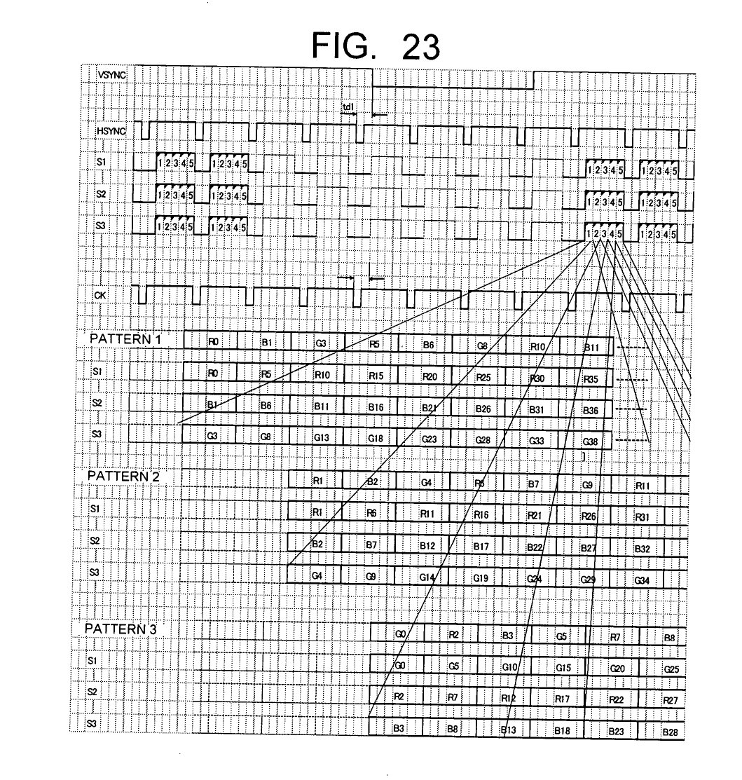

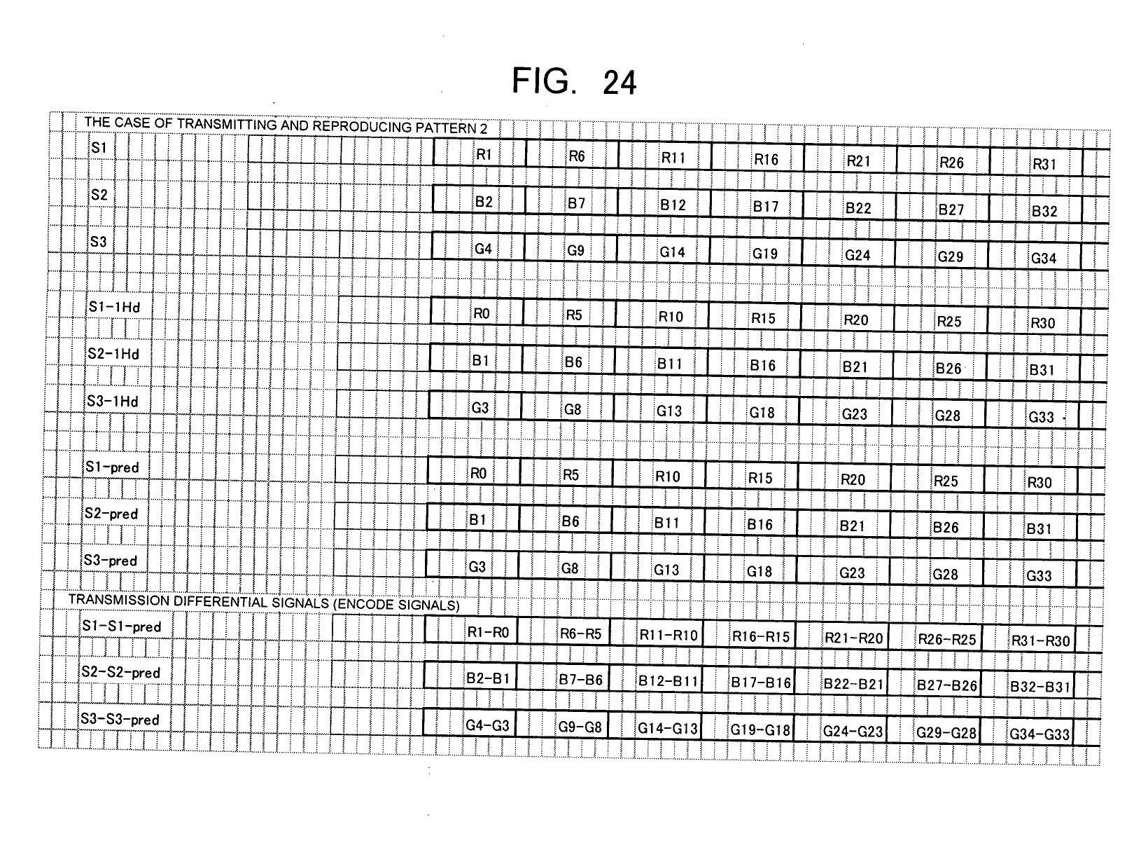

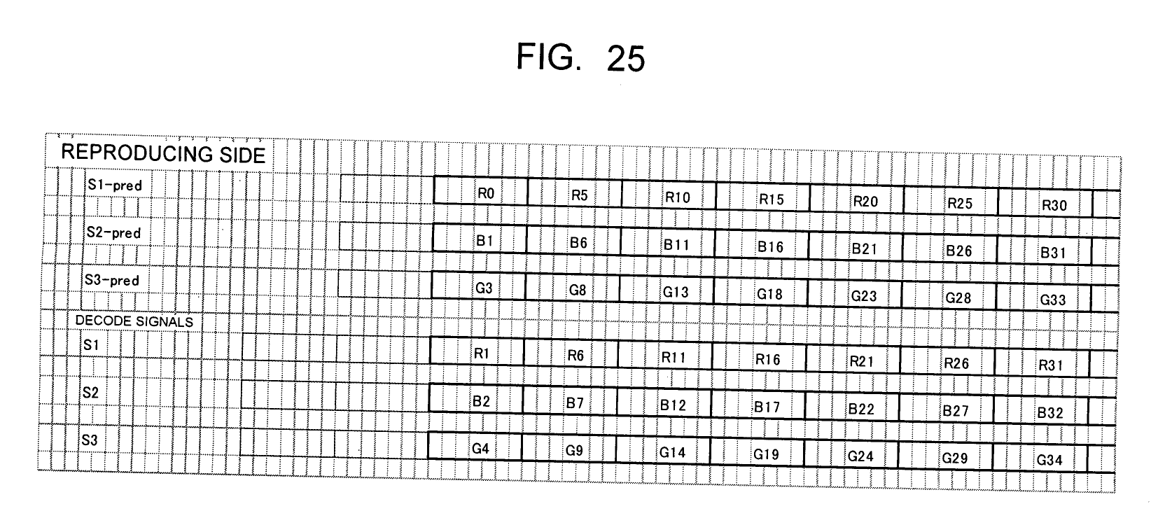

FIG. 22 to FIG. 25 are views showing timing charts for the 5 number of divisions. Note that the sampling pattern in this case is shown in FIG. 9A to FIG. 9C.

### Modification Example of the First Embodiment

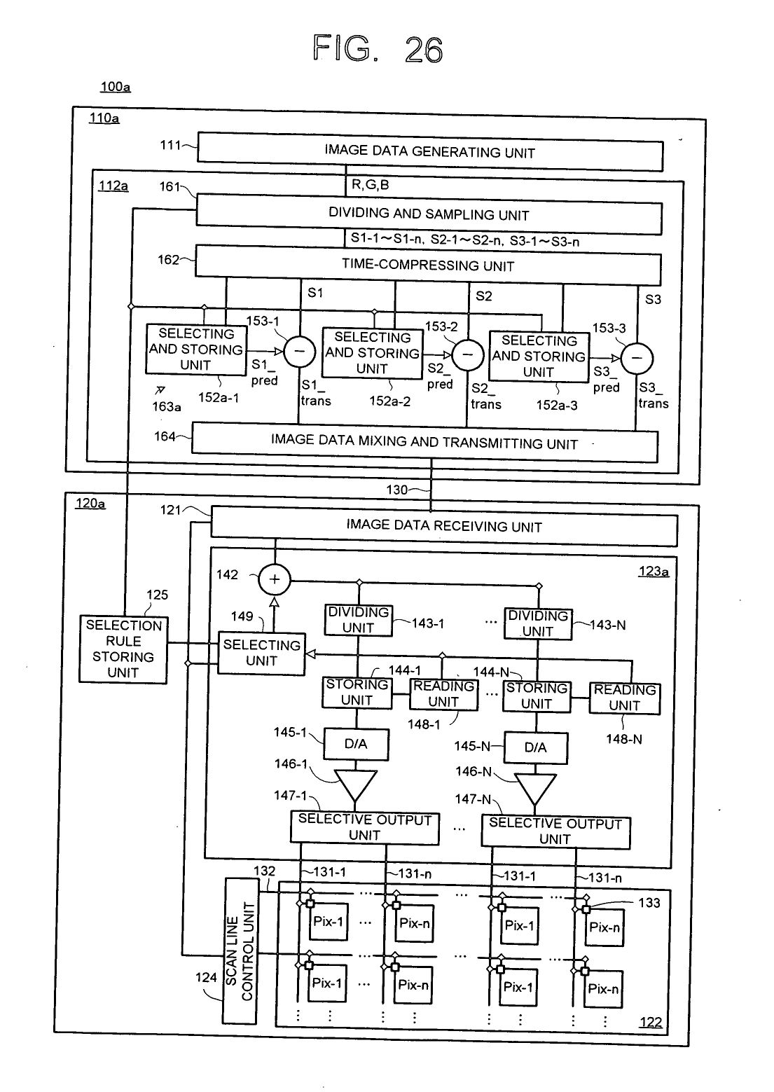

FIG. 26 is a block diagram representing a display system 100a according to a modification example of the first embodiment of the present invention.

In this modification example, differential data are not quantized when being transmitted. Accordingly, a differential data generating unit 163a does not have the quantizing units 154 in the first embodiment, and furthermore, it does not have the storing units 151, the selecting units 152, the dequantizing units 155, and the adding units 156. In other words, configurations regarding the quantization itself and the accumulation of quantization errors are excluded, and instead of them, selecting and storing units 152a are arranged and the predicted values S_pred are selected from the output itself from a time-compressing unit 162.

Also, in a signal line control unit 123a, the dequantizing unit 141 in the first embodiment is excluded.

Except the above points, this modification example is not essentially different from the first embodiment, so that the detailed description will be omitted.

### Second Embodiment

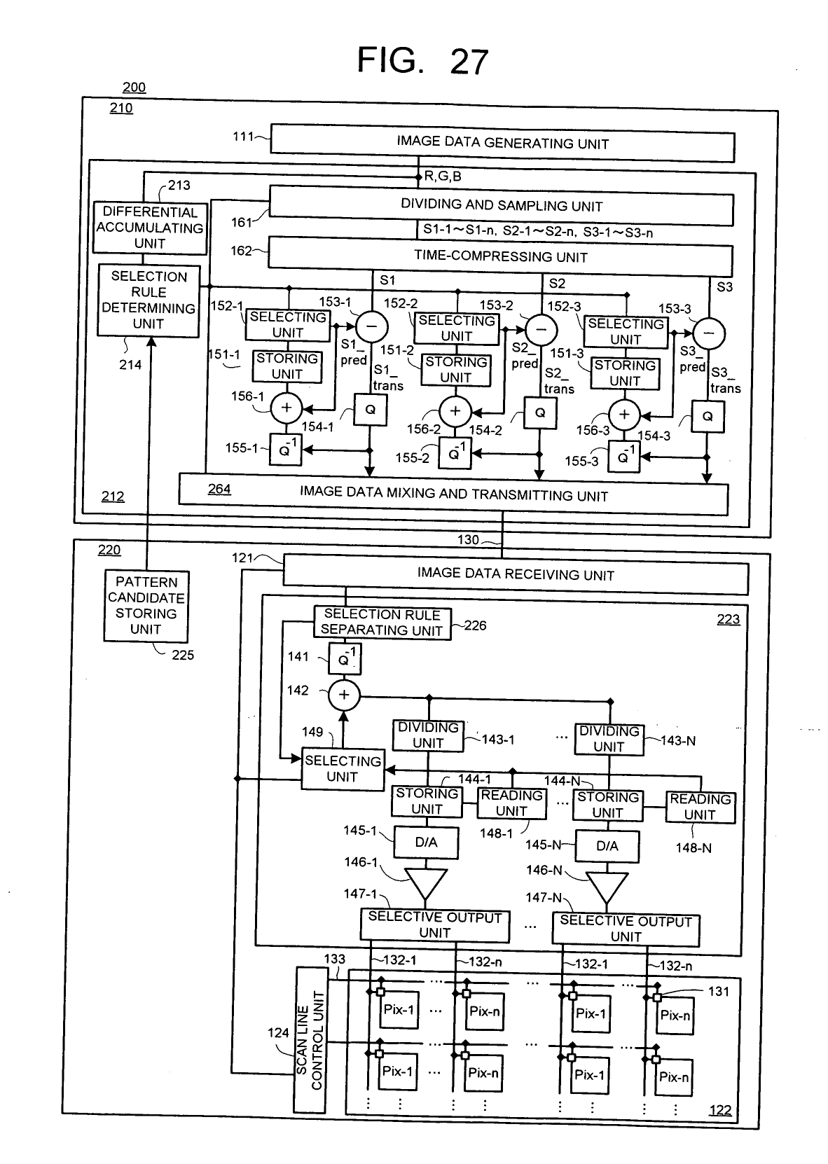

FIG. 27 is a block diagram representing a display system 200 according to a second embodiment of the present invention.

In this embodiment, selection rules are determined on an image data transmitting device 210 side and transmitted with differential data to an image data receiving device 220. Accordingly, the image data transmitting device 210 has a differential accumulating unit 213 and a selection rule determining unit 214.

The differential accumulating unit 213 generates various differential data based on sampling pattern candidates and accumulates absolute values of differences of the respective sampling pattern candidates. The sampling pattern candidates are obtained from a pattern candidate storing unit 225 in the image data receiving device 220.

The selection rule determining unit 214 determines a sampling pattern and selection rules suitable for the sampling pattern, based on accumulation results in the differential accumulating unit 213.

(Operation of the Display System 200)

Hereinafter, operation of the display system 200 being divided for the image data transmitting device 210 and for the image data receiving device 220 will be described.

A. Operation on the Image Data Transmitting Device 210 Side

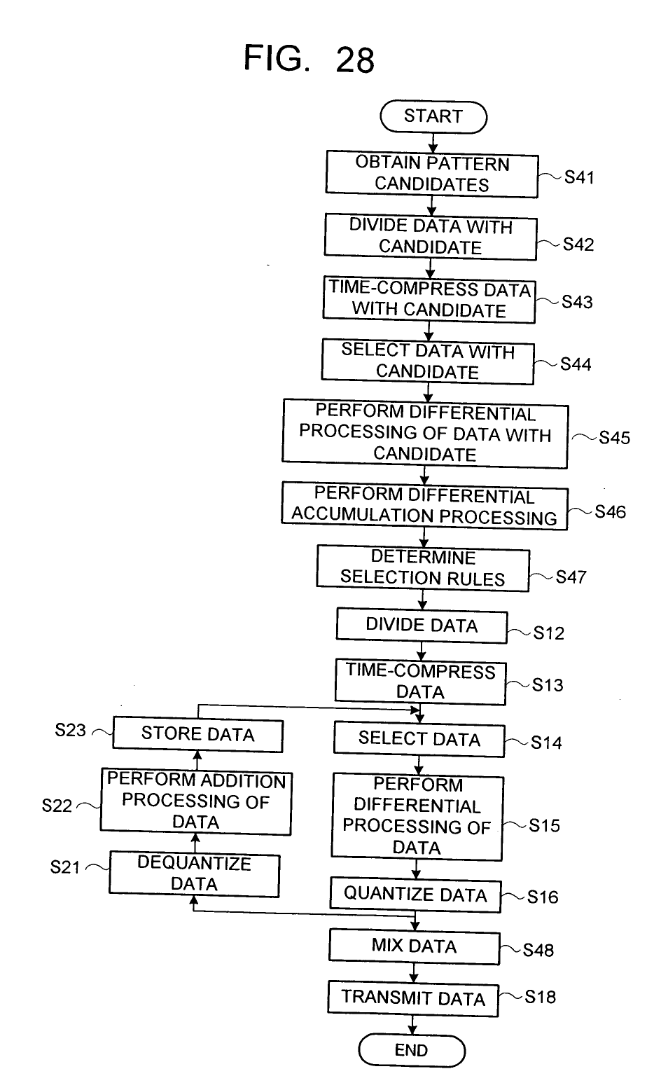

FIG. 28 is a flowchart representing an example of an operation procedure of the image data transmitting device 210. Instead of obtaining selection rules (Step S11) in the flowchart in FIG. 2, Steps S41 to S47 of determining selection rules are executed.

(1) Obtaining Sampling Pattern Candidates (Step S41)

The image data transmitting device 210 obtains (for example, reads, receives) sampling pattern candidates (for example, sampling pattern candidates 1 to m) stored in the pattern candidate storing unit 225. If the obtained sampling pattern candidates are stored in a memory or the like, the later processing becomes easy.

(2) Dividing and Time-Compressing Image Data with the Sampling Pattern Candidates (Steps S42, S43)

Based on the sampling pattern candidates, dividing, sampling, and time-compressing of image data are performed. Note that results of sampling and time-compressing a display image F(x, y) are designated as G1(x, y) to Gm(x, y).

(3) Performing Selecting and Differential Processing of Image Data (Steps S44, S45)

In the following, predicted pixels are determined for G(x, y), and differences thereof are calculated. Based on Principle 1) to Principle 3), data of pixels adjacent to pixels of image data to be transmitted are selected from the sampled image data, which are designated as predicted pixel values S_pred. Further, differences of the selected predicted pixel values S_pred from pixel values S to be transmitted are taken to generate a candidate for the transmission signals S_trans. Note that since the selection rules are not determined yet, it is possible that a plurality of candidates for the transmission signals S_trans are generated for every sampling pattern candidate.

As this candidate for the transmission signals S_trans, sets 1 to m of differential data groups according to the sampling pattern candidates 1 to m are generated.

(4) Performing Differential Accumulation Processing and Determining Selection Rules (Steps S46, S47)

Sets 1 to m of differential data groups are generated in parallel, and absolute values of differences thereof are accumulated.

Sums of absolute values of respective differential values being accumulated for one line are designated as AccError1 to AccErrorm. Since it is conceivable that the smallest one in the AccError1 to AccErrorm is one having high correlation between data, so that a sampling pattern candidate at this moment is determined as the sampling pattern. Specifically, an optimum sampling pattern and set of selection rules are determined from the sampling patterns 1 to m.

Incidentally, instead of the accumulation of the absolute values of differences, other methods such as sums of squared differences, weighted accumulation, and the like can also be appropriately used.

(5) After Determination of the Selection Rules (Steps S12 to S18, S21 to S23)

After the selection rules and the sampling pattern are determined, similarly to the case of first embodiment, differential processing is performed in accordance with the determined selection rules and sampling pattern.

Note that in consideration of a certain time being required for determination of selection rules, a delay processing unit may be provided between the image data generating unit 111 and the dividing and sampling unit 161 so as to delay the start of processing in the dividing and sampling unit 161, the time-compressing unit 162, the differential data generating unit 163, and the image data mixing and transmitting unit 164.

B. Operation on the Image Data Receiving Device 220 Side

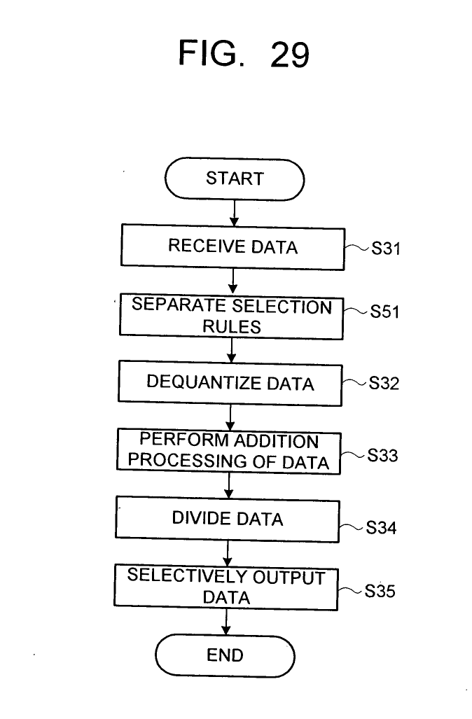

FIG. 29 is a flowchart representing an example of an operation procedure of the image data receiving device 220. Between receiving data and dequantizing (Steps S31, S32) in FIG. 3, Step S51 of separating the sampling pattern and the selection rules from the received data is performed.

C. Timing Charts

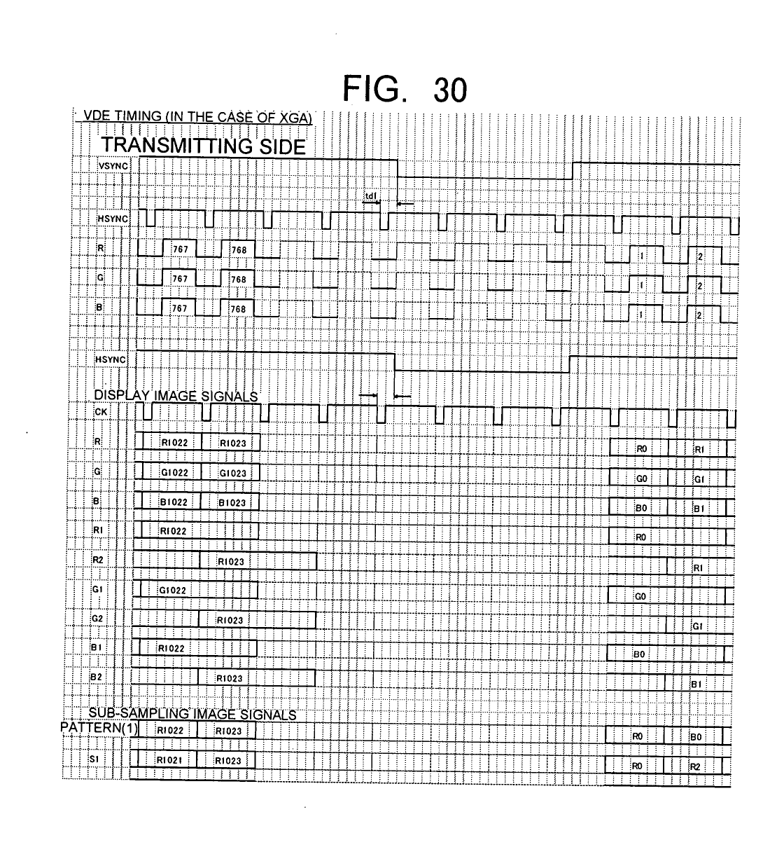

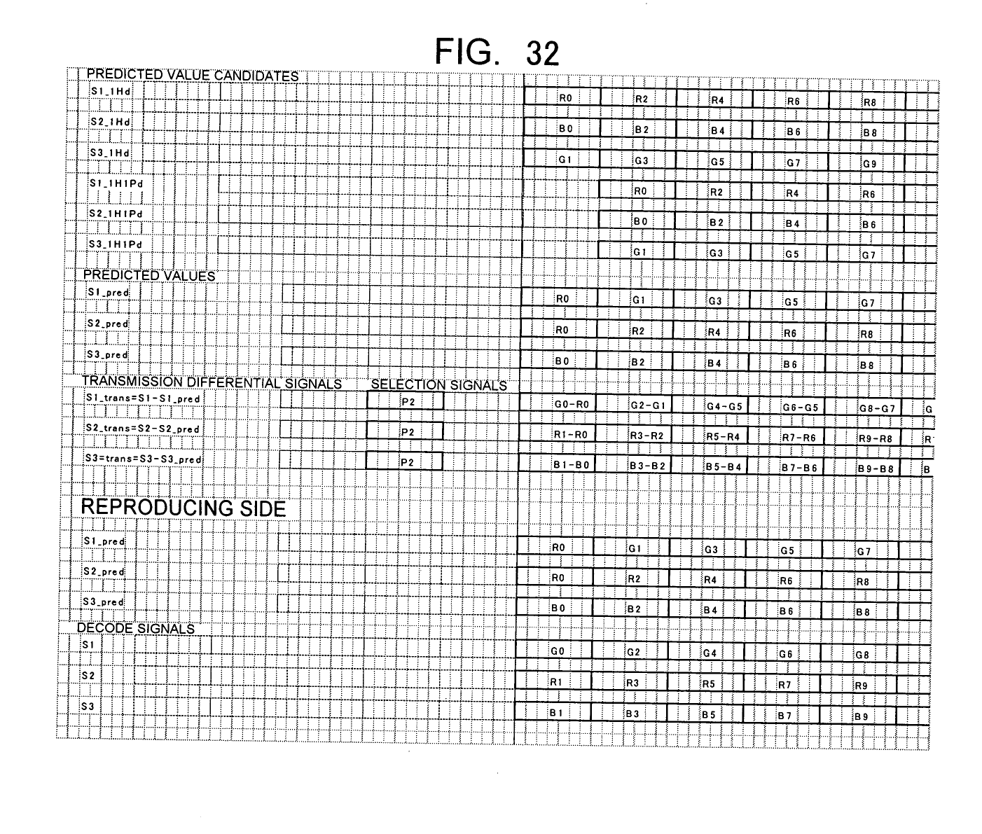

FIG. 30 to FIG. 32 are views showing examples of timing charts for the display system 200.

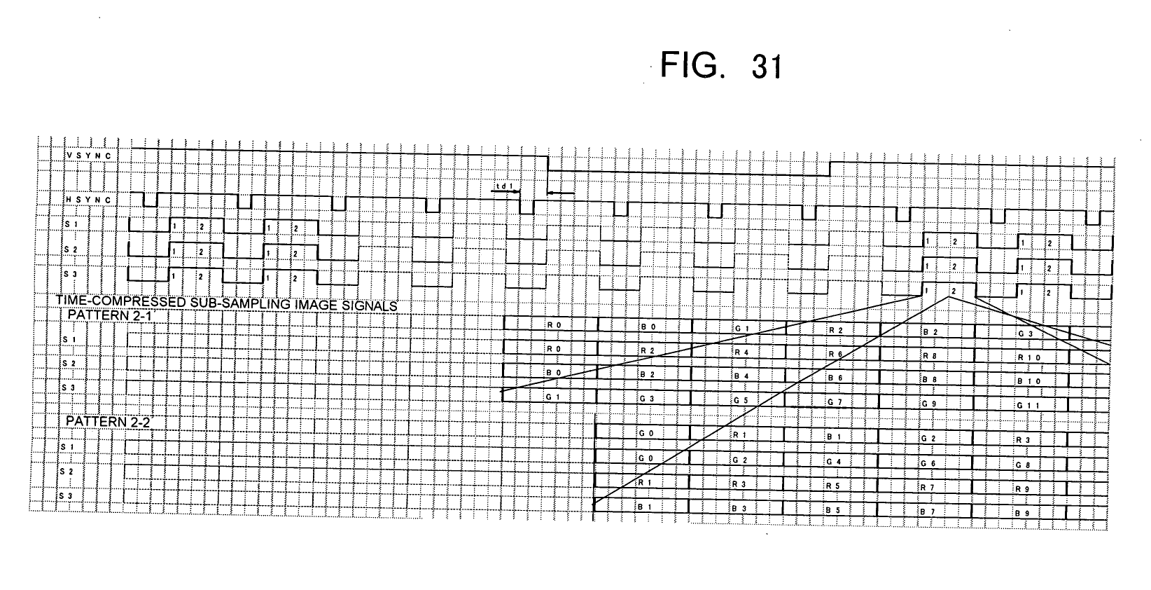

Here, the case of two divisions where P1 (pattern 1) is selected as the selection pattern is presented as an example. As shown in FIG. 31, before transmitting a differential pixel signal, a signal indicating the selection of the pattern P1 is transmitted.

Thus, according to the present invention, a difference from an adjacent pixel within one pixel can be transmitted and reproduced on the receiving side constantly, so that reduction of EMI and power consumption can be realized even in a system using a driver of p-Si switch method that is capable of reducing cost.

### Other Embodiments

In the foregoing, the embodiments of the present invention have been described, but the present invention is not limited to these embodiments and can be implemented by various modifications without departing from the spirit of the present invention. For example, the embodiments of the present invention are not limited to liquid crystal display devices, and can be applied to any kind of display devices in which pixels are arranged in a matrix form, such as organic EL (Electro Luminescence), PDP (Plasma Display Panel), and the like.

What is claimed is:

1. An image data processing apparatus, comprising:
a dividing unit configured to divide image data including a plurality of pixel data into the plurality of pixel data including a set of pixel data corresponding to a set of signal lines of a display device selectively controlled by an element;
a storing unit configured to store the plurality of pixel data divided by the dividing unit;
a selecting unit configured to select a first pixel data from the plurality of pixel data stored by the storing unit corresponding to a second pixel data included in the plurality of pixel data divided by the dividing unit; and
a differentiating unit configured to generate differential data from the first pixel data selected by the selecting unit and the second pixel data included in the plurality of pixel data divided by the dividing unit.

2. The image data processing apparatus as set forth in claim 1, further comprising:
a reproducing unit configured to reproduce pixel data from the differential data generated by the differentiating unit;
the display device having a plurality of signal lines including a plurality of sets of signal lines, a plurality of scan lines, and a plurality of pixels driven by the plurality of signal lines and the plurality of scan lines; and
a plurality of elements, each of which controls selectively each set of signal lines included in a plurality of signal lines based on the pixel data reproduced by the reproducing unit.

3. The image data processing apparatus as set forth in claim 2,
wherein the first pixel data and the second pixel data are corresponding to one of a same set of signal lines and adjacent sets of signal lines.

4. The image data processing apparatus as set forth in claim 2,
wherein the plurality of pixels display a plurality of colors.

5. The image data processing apparatus as set forth in claim 4,
wherein the first pixel data and the second pixel data are corresponding to a same color displayed by pixels.

6. The image data processing apparatus as set forth in claim 2,
wherein said element controls selectively the set of signal lines in an order according to the plurality of scan lines.

7. The image data processing apparatus as set forth in claim 2,
wherein the element controls selectively the set of signal lines in a first order or in a second order in inverse to the first order according to the plurality of scan lines.

8. The image data processing apparatus as set forth in claim 2,
wherein said selecting unit selects the first pixel data based on a number of signal lines within the set of the signal lines.

9. The image data processing apparatus as set forth in claim 2,
wherein said selecting unit selects the first pixel data based on an order of selectively controlling of the set of signal lines by the element.

10. The image data processing apparatus as set forth in claim 2, further comprising:
a bit number changing unit configured to change the number of bits of the generated differential data,
wherein said reproducing unit reproduces pixel data from the differential data in which the number of bits is changed by the bit number changing unit.

11. An image data processing method, comprising:
dividing image data including a plurality of pixel data into the plurality of pixel data including a set of pixel data corresponding to a set of signal lines of a display device selectively controlled by an element;
storing the divided plurality of pixel data;
selecting a first pixel data from the stored plurality of pixel data corresponding to a second pixel data included in the divided plurality of pixel data; and
generating differential data from the first pixel data and the second pixel data.

12. The image data processing method as set forth in claim 11, further comprising:
reproducing pixel data from the generated differential data;
controlling selectively the set of signal lines of the display by the element based on the reproduced pixel data, wherein the display device has a plurality of signal lines including a plurality of sets of signal lines, a plurality of scan lines, and a plurality of pixels driven by the plurality of signal lines and the plurality of scan lines.

13. The image data processing method as set forth in claim 12,
wherein the first pixel data and the second pixel data are corresponding to one of a same set of signal lines and adjacent sets of signal lines.

14. The image data processing method as set forth in claim 12,
wherein the plurality of pixels display a plurality of colors.

15. The image data processing method as set forth in claim 14,
wherein the first pixel data and the second pixel data corresponding to a same color displayed by pixels.

16. The image data processing method as set forth in claim 12,
wherein said controlling includes controlling selectively the set of signal lines in an order according to the plurality of scan lines.

17. The image data processing method as set forth in claim 12,
wherein said controlling includes controlling selectively the set of signal lines in a first order or in a second order in inverse to the first order according to the plurality of scan lines.

18. The image data processing method as set forth in claim 12,
wherein said selecting includes selecting the first pixel data based on a number of signal lines within the set of the signal lines.

19. The image data processing method as set forth in claim 12,
wherein said selecting includes selecting the first pixel data based on an order of controlling selectively signal lines in said controlling.

20. The image data processing method as set forth in claim 12, further comprising:
changing the number of bits of the generated differential data,
wherein said reproducing includes reproducing pixel data from the differential data in which the number of bits is changed.
